(19) United States
(12) Patent Application Publication
(10) Pub. No.: US 2025/0387816 A1
(43) Pub. Date: Dec. 25, 2025

(54) SYSTEM, APPARATUS AND METHOD FOR SEQUESTRATION OF CARBON

(71) Applicants: Daniel K. Carstens, Santa Ana, CA (US); Christopher Carstens, Hyde Park, NY (US); Douglas P. Dufaux, Orchard Park, NY (US); Carbo Culture, Inc., Covina, CA (US)

(72) Inventors: Daniel K. Carstens, Santa Ana, CA (US); Christopher Carstens, Hyde Park, NY (US); Douglas P. Dufaux, Orchard Park, NY (US)

(73) Assignee: Carbo Culture, Inc., Covina, CA (US)

(21) Appl. No.: 18/879,613

(22) PCT Filed: Jun. 26, 2023
(86) PCT No.: PCT/US2023/069079

§ 371 Date: Dec. 27, 2024

Related U.S. Application Data
(60) Provisional application No. 63/355,911, filed on Jun. 27, 2022.

(51) Int. Cl. B09B 1/00; B09B 101/85

(52) U.S. Cl. CPC B09B 1/002; B09B 2101/85

(57) ABSTRACT

A system for producing one or more high-density fragments comprising carbon from an organic material and methods for making and using the same. The system can include increasing a density of the organic material to form the high-density fragments and can determine a critical submersion depth for the high-density fragments. The critical submersion depth can comprise a depth below a water surface of a body of water at which the high-density fragments must be submerged such that a density of the high-density fragments is greater than the density of the body of water. The system can submerge the high-density fragments in the body of water at a predetermined injection depth that is below the critical submersion depth so that the high-density fragments will sink to a floor of the body of water. Thereby, the system advantageously can produce a product comprising a mixture of carbon and water.

### CROSS-REFERENCE TO RELATED APPLICATIONS

This application claims the benefit of, and priority to, U.S. Provisional Application Ser. No. 63/355,911, filed on Jun. 27, 2022, the disclosure of which is hereby incorporated herein by reference in its entirety and for all purposes.

### FIELD

The disclosed embodiments relate generally to the field of carbon production and more particularly, but not exclusively, to systems, apparatuses and methods for sequestration of carbon and products comprising carbon formed pursuant to the sequestration systems, apparatuses and methods.

### BACKGROUND

Under suitable conditions, wood may be stored in water for hundreds of years, at a minimum. Proof of this has been uncovered in recent years through the discovery of centuries-old wooden ships at the bottom of several bodies of water, including oceans and great lakes. The conditions required to allow such long-term storage may not be fully known, but the number of locations with identified wrecks and other deposits continually grows. Common traits seem to be deep, cold water where oxygen levels are low with both traits contributing to a low level of decay.

A wide variety of processes have been proposed to sequester carbon. Many sequestration methods use biomass as a starting material, taking advantage of the work done by nature to convert atmospheric carbon (in the form of carbon dioxide) to plant matter and other matter containing carbon. Systems, apparatuses and methods are needed to lock-in the carbon within biomass for long periods of time and at low costs.

### SUMMARY

The present disclosure relates to systems for producing one or more high-density fragments comprising carbon from an organic material and methods for making and using the same. The system can include increasing a density of the organic material to form the high-density fragments and can determine a critical submersion depth for the high-density fragments. The critical submersion depth can comprise a depth below a water surface of a body of water at which the high-density fragments must be submerged such that a density of the high-density fragments is greater than the density of the body of water. The system can submerge the high-density fragments in the body of water at a predetermined injection depth that is below the critical submersion depth so that the high-density fragments will sink to a floor of the body of water. Thereby, the system advantageously can produce a product comprising a mixture of carbon and water.

In accordance with a first aspect disclosed herein, there is set forth a method for creating submerged carbon-containing material that can comprise:
determining a critical submersion depth below a water surface of a body of water for one or more fragments containing carbon and defining one or more gas pockets, the fragments having a first fragment density that is less than a first water density of the body of water above the critical submersion depth and that is greater than a second water density below the critical submersion depth;
disposing the fragments in the body of water at a predetermined injection depth that is greater than the critical submersion depth; and/or
permitting the fragments containing carbon and having the second density being greater than the second water density to sink to a floor of the body of water.

In some embodiments of the disclosed method of the first aspect, disposing the fragments in the body of water can include exposing the fragments to pressure for compressing the gas pockets to increase the first fragment density of the fragments to a second fragment density that is greater than the first fragment density. The fragments optionally can be exposed to hydrostatic pressure from the body of water. For example, the fragments can be exposed to an increasing hydrostatic pressure that increases with a depth within the body of water, the increasing hydrostatic pressure further compressing the gas pockets and further increasing the second fragment density of the fragments to a third fragment density that is greater than the second fragment density.

In some embodiments of the disclosed method of the first aspect, disposing the fragments in the body of water can include exposing the fragments to pressure for filling the gas pockets with water from the body of water to increase the first fragment density of the fragments to a second fragment density that is greater than the first fragment density.

In some embodiments, the disclosed method of the first aspect can further comprise characterizing feedstock for conversion into the fragments containing carbon. Characterizing the feedstock, for example, can include ensuring that the feedstock is suitable for submersion in the body of water, determining a moisture content of the feedstock and/or determining a size, shape or other dimension of the feedstock.

In some embodiments, the disclosed method of the first aspect can further comprise determining whether an adjustment to a dimension of the fragments is needed. Determining whether the adjustment to the dimension of the fragments is needed, for example, can include sorting the fragments to determine whether a dimension of a selected fragment is greater than a first predetermined fragment dimension threshold, and reducing the dimension of the selected fragment based upon the sorting the fragments, and/or determining the critical submersion depth can comprise determining the critical submersion depth for the selected fragment with the reduced dimension. Determining whether the adjustment to the dimension of the fragments is needed optionally can include determining whether the reduced dimension of the selected fragment is greater than the first predetermined fragment dimension threshold, and/or further reducing the reduced dimension of the selected fragment based upon the determining whether the reduced dimension of the selected fragment is greater than the first predetermined fragment dimension threshold. The critical submersion depth for the selected fragment with the further reduced dimension then can be determined.

Additionally and/or alternatively, determining whether the adjustment to the dimension of the fragments is needed can include sorting the fragments to determine whether a dimension of a selected fragment is less than a second predetermined fragment dimension threshold, and increasing the dimension of the selected fragment based upon the sorting the fragments, and/or determining the critical submersion depth can comprise determining the critical submersion depth for the selected fragment with the increased dimension. Determining whether the adjustment to the dimension of the fragments is needed optionally can include determining whether the increased dimension of the selected fragment is less than the second predetermined fragment dimension threshold, and further increasing the increased dimension of the selected fragment based upon the determining whether the increased dimension of the selected fragment is greater than the second predetermined fragment dimension threshold. The critical submersion depth for the selected fragment with the further increased dimension then can be determined.

In selected embodiments, the first predetermined fragment dimension threshold can be equal to the second predetermined fragment dimension threshold. Determining whether the adjustment to the dimension of the fragments is needed optionally can comprise determining whether an adjustment to a size of the fragments is needed and/or determining whether an adjustment to a shape of the fragments is needed.

In some embodiments, the disclosed method of the first aspect can further comprise confirming that the fragments containing carbon remain submerged after sinking to the floor.

In some embodiments, the disclosed method of the first aspect can further comprise determining that a predetermined amount of the fragments have been disposed in the body of water and terminating the disposing the fragments in the body of water based upon the determining that the predetermined amount of the fragments have been disposed in the body of water. Additionally and/or alternatively, the disclosed method of the first aspect can further comprise documenting a mass of the fragments at the floor of the body of water.

In accordance with a second aspect disclosed herein, there is set forth a system for creating submerged carbon-containing material, wherein the system comprises means for carrying out each embodiment of the method of the first aspect.

In accordance with a third aspect disclosed herein, there is set forth a computer program for creating submerged carbon-containing material, wherein the computer program product comprises instruction for carrying out each embodiment of the method of the first aspect. The computer program product of the third aspect optionally being encoded on one or more non-transitory machine-readable storage media.

In accordance with a fourth aspect disclosed herein, there is set forth a method for creating submerged carbon-containing material that can comprise:
disposing one or more fragments containing carbon and defining one or more gas pockets into a hopper loading section of a hopper system;
pumping the fragments from the hopper loading section of the hopper system into a proximal end region of a discharge pipe system having a distal end region extending below a water surface of a body of water to a predetermined injection depth below the water surface being greater than a critical submersion depth below the water surface for the fragments; and/or
discharging the fragments containing carbon from the distal end region of the discharge pipe system,
wherein the fragments discharged from the distal end region of the discharge pipe sink

to a floor of the body of water.

In some embodiments of the disclosed method of the fourth aspect, disposing the fragments can include delivering the fragments to the hopper loading section via a front-end loader system.

In some embodiments of the disclosed method of the fourth aspect, disposing the fragments can include delivering the fragments to the hopper loading section via a conveyor system. A mass of the fragments on a selected track segment of the conveyor system optionally can be determined. For example, the mass of the fragments can be determined via the conveyor system. Additionally and/or alternatively, a speed of the conveyor system can be adjusted based upon the determined mass of the fragments.

In some embodiments, the disclosed method of the fourth aspect can further comprise delivering water to the hopper loading section of the hopper system, wherein the pumping the fragments can comprise pumping the fragments and the water from the hopper loading section of the hopper system into a proximal end region of a discharge pipe system. Water from the body of water, for example, can be delivered to the hopper loading section of the hopper system.

In some embodiments, the disclosed method of the fourth aspect can further comprise applying pressure to the fragments moving from the proximal end region of the discharge pipe system to the distal end region of the discharge pipe system to increase a fragment density of the fragments, wherein the fragment density is greater than a water density of the body of water at the predetermined injection depth.

In some embodiments of the disclosed method of the fourth aspect, the proximal end region of the discharge pipe system can be disposed below the water surface of the body of water. The proximal end region of the discharge pipe system alternatively can be disposed above the water surface of the body of water.

In some embodiments of the disclosed method of the fourth aspect, at least a portion of the hopper system can be disposed below the water surface of the body of water. The hopper system, in other words, can be disposed in whole or in part below the water surface of the body of water. Additionally and/or alternatively, at least a portion of the hopper system is disposed above the water surface of the body of water. Stated somewhat differently, the hopper system can be disposed in whole or in part above the water surface of the body of water.

In accordance with a fifth aspect disclosed herein, there is set forth a system for creating submerged carbon-containing material, wherein the system comprises means for carrying out each embodiment of the method of the fourth aspect.

In accordance with a sixth aspect disclosed herein, there is set forth a computer program for creating submerged carbon-containing material, wherein the computer program product comprises instruction for carrying out each embodiment of the method of the fourth aspect. The computer program product of the sixth aspect optionally being encoded on one or more non-transitory machine-readable storage media.

In accordance with a seventh aspect disclosed herein, there is set forth a method for creating submerged carbon-containing material. The method of the seventh aspect advantageously can create the submerged carbon-containing material via a submersion vessel.

The submersion vessel can comprise an elongated body that can include first and second opposite end regions and that defines an internal channel extending from the first end region to the second end region. The first end region can define a first opening that communicates with the internal channel and that alternates between an open state for permitting access to the internal channel via the first opening and a closed state for inhibiting access to the internal channel via the first opening. Additionally and/or alternatively, the second end region can define a second opening that communicates with the internal channel and that alternates between an open state for permitting access to the internal channel via the second opening and a closed state for inhibiting access to the internal channel via the second opening. In selected embodiments, the elongated body can include a pressure sensing port adjacent to the first end region and being configured for determining an internal pressure inside the internal channel and a water supply port adjacent to the second end region and being configured for controlling a fluid exchange between the internal channel and a fluid pressure source system.

The method of the seventh aspect can comprise:
positioning the submersion vessel in a loading position with the first end region being in the open state and the second end region being in the closed state;
disposing one or more fragments containing carbon and defining one or more gas pockets into the internal channel of the submersion vessel via the first opening of the first end region;
transitioning the first end region from the open state to the closed state;
submerging the second end region of the submersion vessel below a water surface of a body of water to a predetermined injection depth below the water surface being greater than a critical submersion depth below the water surface for the fragments;
disposing water into the internal channel of the submersion vessel via the water supply port; and/or
transitioning the second end region from the closed state to the open state,
wherein the fragments exit the internal channel via the second end region and sink to a floor of the body of water.

In accordance with an eighth aspect disclosed herein, there is set forth a system for creating submerged carbon-containing material, wherein the system comprises means for carrying out each embodiment of the method of the seventh aspect.

In accordance with a ninth aspect disclosed herein, there is set forth a computer program for creating submerged carbon-containing material, wherein the computer program product comprises instruction for carrying out each embodiment of the method of the seventh aspect. The computer program product of the ninth aspect optionally being encoded on one or more non-transitory machine-readable storage media.

In accordance with a tenth aspect disclosed herein, there is set forth a method for creating submerged carbon-containing material that can comprise:
applying an applied pressure that is different from an atmospheric pressure to a feedstock containing carbon; and/or
sequestering the pressurized feedstock in a body of water.

The method of the tenth aspect, in other words, can comprise:
applying an applied pressure to a feedstock containing carbon; and/or
sequestering the pressurized feedstock in a body of water,
wherein the applied pressure is different from an atmospheric pressure.

In some embodiments of the disclosed method of the tenth aspect, applying the applied pressure can comprise applying the applied pressure that is greater than the atmospheric pressure to the feedstock.

In some embodiments of the disclosed method of the tenth aspect, applying the applied pressure can comprise applying the applied pressure that is less than the atmospheric pressure to the feedstock. The applied pressure that is less than the atmospheric pressure optionally comprise a vacuum.

In some embodiments of the disclosed method of the tenth aspect, sequestering the pressurized feedstock can comprise sequestering the pressurized feedstock in a body of fresh water and/or sequestering the pressurized feedstock in a body of salt water.

In some embodiments of the disclosed method of the tenth aspect, sequestering the pressurized feedstock can comprise sinking the pressurized feedstock in the body of water.

In some embodiments of the disclosed method of the tenth aspect, the feedstock can comprise a biomass. Additionally and/or alternatively, the feedstock can comprise one or more fragments containing carbon.

In some embodiments of the disclosed method of the tenth aspect, the feedstock can comprise at least one low-density structure that is capable of being compressed. The feedstock, for example, can define one or more gas pockets. At least one of the gas pockets optionally can contain air.

In some embodiments of the disclosed method of the tenth aspect, applying the applied pressure can comprise applying the applied pressure for compressing the at least one low-density structure of the feedstock.

In some embodiments of the disclosed method of the tenth aspect, applying the applied pressure can comprise applying the applied pressure for increasing a feedstock density of the feedstock. The feedstock density of the feedstock, for example, can be increased to be less than a first water density of the body of water above a critical submersion depth. Additionally and/or alternatively, the feedstock density of the feedstock can be increased to be greater than a second water density of the body of water below the critical submersion depth.

In selected embodiments, sequestering the pressurized feedstock can comprise submerging the feedstock in the body of water. The feedstock, for example, can be disposed in the body of water at a predetermined injection depth that is greater than the critical submersion depth. Applying the applied pressure optionally can comprise applying the applied pressure for enabling the feedstock to become negatively buoyant. Additionally and/or alternatively, sequestering the pressurized feedstock can comprise sinking the feedstock in the body of water after the at least one low-density structure of the feedstock is compressed.

In accordance with an eleventh aspect disclosed herein, there is set forth a system for creating submerged carbon-containing material, wherein the system comprises means for carrying out each embodiment of the method of the tenth aspect.

In accordance with a twelfth aspect disclosed herein, there is set forth a computer program for creating submerged carbon-containing material, wherein the computer program product comprises instruction for carrying out each embodiment of the method of the tenth aspect. The computer program product of the twelfth aspect optionally being encoded on one or more non-transitory machine-readable storage media.

### BRIEF DESCRIPTION OF THE DRAWINGS

For a fuller understanding of the nature and objects of the disclosure, reference should be made to the following detailed description taken in conjunction with the accompanying drawings. These accompanying drawings constitute a part of this specification and illustrate various embodiments, in which:

FIG. 1A is a top-level block diagram illustrating an exemplary embodiment of a system for locking-in carbon within a mass, wherein a mass containing carbon is disposed in a body of water.

FIG. 1B is a top-level block diagram illustrating an exemplary alternative embodiment of the system of FIG. 1A, wherein the mass loses buoyancy and sinks to a predetermined depth in the body of water due to hydrostatic pressure from the body of water.

FIG. 1C is a top-level block diagram illustrating another exemplary alternative embodiment of the system of FIG. 1A, wherein the mass sinks to a floor of the body of water.

FIG. 2A is a top-level block diagram illustrating an exemplary alternative embodiment of the system of FIGS. 1A-C, wherein the system is configured for producing high density carbon-containing materials and depositing the materials at the floor of the body of water.

FIG. 2B is a top-level block diagram illustrating an exemplary alternative embodiment of the system of FIG. 2A, wherein at least a portion of the system is submerged below a surface of the body of water.

FIG. 3 is a top-level flow chart illustrating an exemplary embodiment of a method for creating submerged carbon-containing material.

FIG. 4A is a top-level flow chart illustrating an exemplary alternative embodiment of the method of FIG. 3, wherein the method characterizes feedstock for conversion into fragments containing carbon.

FIG. 4B is a top-level flow chart illustrating an exemplary embodiment of the method of FIG. 4A, wherein the method selects the feedstock and determines a size, shape and/or other dimension of the selected feedstock.

FIG. 4C is a top-level flow chart illustrating an exemplary alternative embodiment of the method of FIG. 4A, wherein the method optionally sorts the fragments and, as needed, adjusts the size, shape and/or other dimension of the feedstock.

FIG. 5 is a top-level block diagram illustrating an exemplary embodiment of a submersion characteristics test apparatus for determining a critical submersion depth for the mass of FIG. 1A.

FIG. 6 is a top-level flow chart illustrating another exemplary alternative embodiment of the method of FIG. 3, wherein the method includes disposing the fragments at a predetermined injection depth below the water surface of the body of water.

FIG. 7A is a top-level flow chart illustrating yet another exemplary alternative embodiment of the method of FIG. 3, wherein the method includes confirming that the fragments remain submerged in the body of water.

FIG. 7B is a top-level flow chart illustrating still another exemplary alternative embodiment of the method of FIG. 3, wherein the method includes determining that a predetermined amount of the fragments have been disposed in the body of water.

FIG. 8A is a top-level block diagram illustrating another exemplary alternative embodiment of the system of FIGS. 1A-C, wherein the system comprises a submersion vessel.

FIG. 8B is a top-level block diagram illustrating an exemplary alternative embodiment of the system of FIG. 8A, wherein at least a portion of the submersion vessel is submerged below the surface of the body of water.

FIGS. 9A-B are top-level block diagrams illustrating yet another exemplary alternative embodiment of the system of FIGS. 1A-C, wherein the system includes a water permeable vessel for submerging the fragments in the body of water.

It should be noted that the figures are not drawn to scale and that elements of similar structures or functions may be generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION OF THE PREFERRED EMBODIMENTS

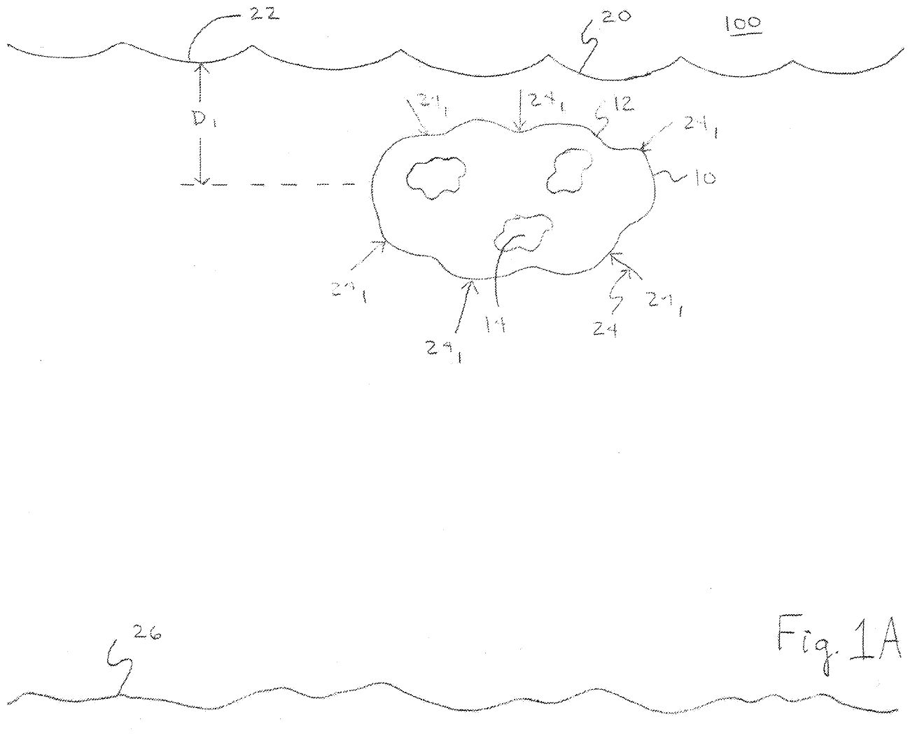

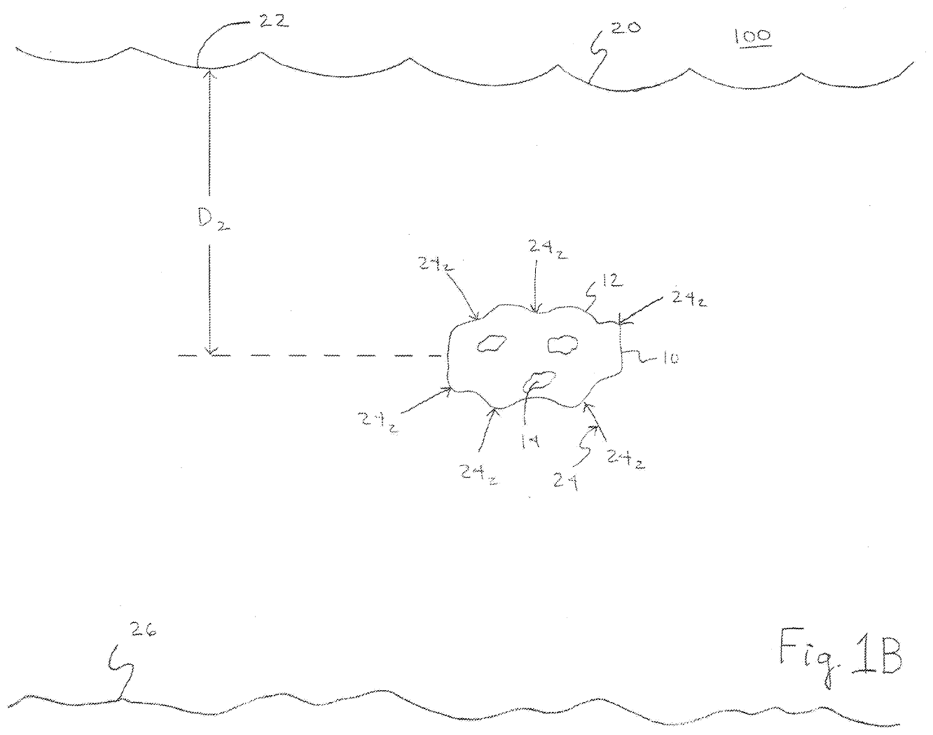

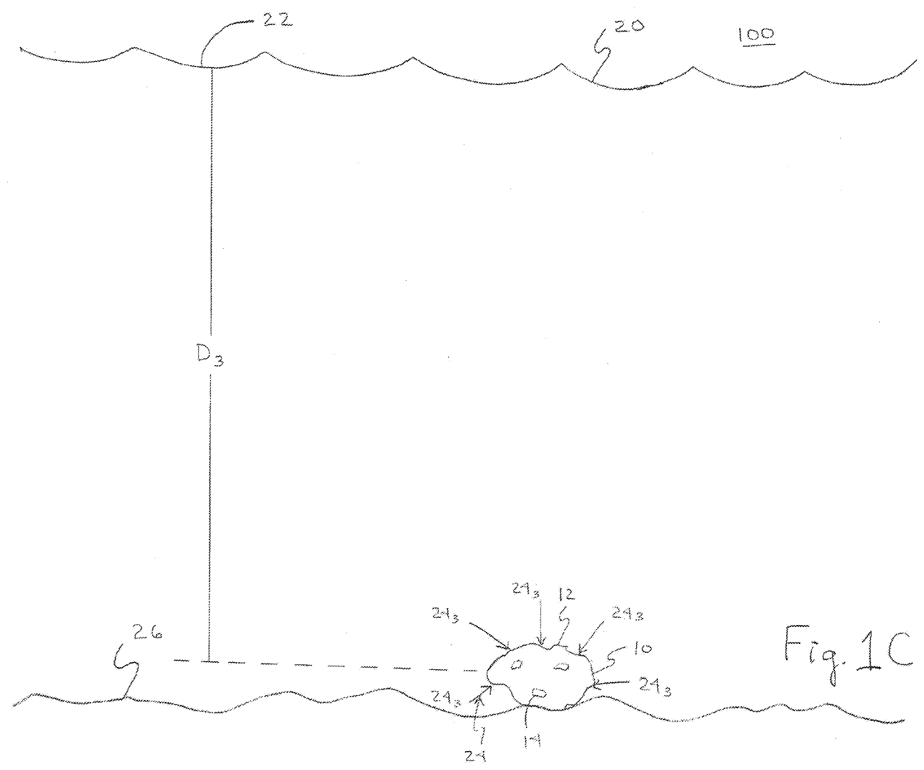

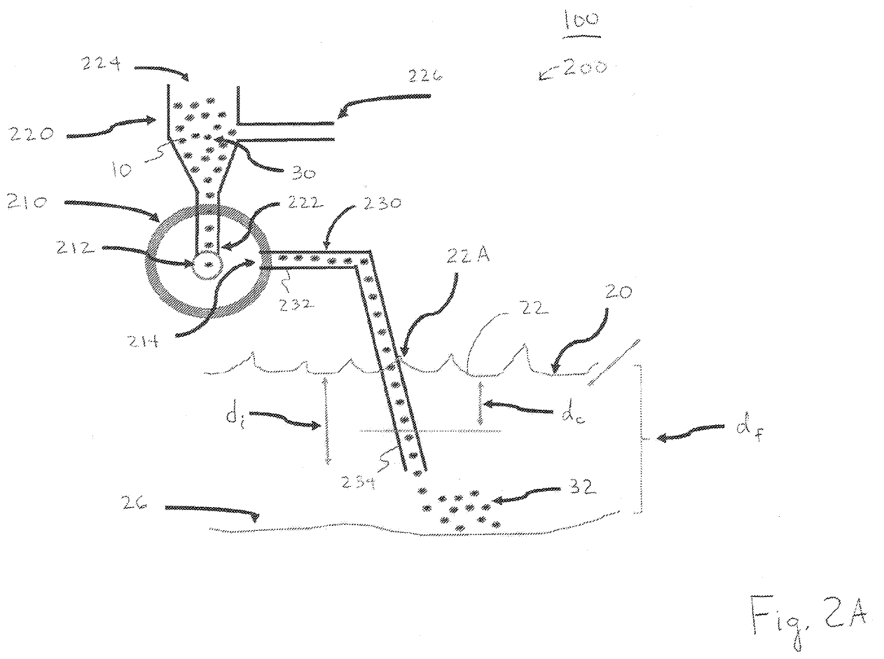

Due to the shortcomings of conventional carbon sequestration processes, a system for locking-in carbon within a biomass, or other form, for long periods of time and at low costs can prove desirable and provide a basis for a wide range of applications. This result can be achieved, according to one embodiment disclosed herein, by a system 100 for locking-in carbon within a mass as illustrated in FIGS. 1A-C. Stated somewhat differently, the system 100 can produce a biomass with a density that is greater than the highest density of water found within a body of water and discharge the biomass into the body of water, wherein the biomass can remain below a surface of the body of water and/or sink to a bottom of the body of water for an extended period of time.

Water in a large body of water may be freshwater, salt water and/or any water occurring naturally or synthetically representing a natural occurring liquid. When in a large body of water, the water often is stratified where the temperature changes as the temperature is measured at the surface to the bottom, or floor, of the body of water. In some cases, the temperature near the surface may be twenty degrees Celsius and higher, while at the same time, the temperature near the bottom may be close to zero Celsius. Water has a maximum density near four degrees Celsius, and that temperature is often found near the bottom of a large body of water due to its associated density. In some instances, the temperature may be colder due to underwater currents and/or other factors. To sink a material to the bottom of the body of water, the density of the material needs to be greater than the density of water at all levels, at the time the material contacts a given layer within the body of water.

In some embodiments, the material deposited on or near the floor of the body of water can be stable and may remain for hundreds of years. Additionally and/or alternatively, the material may be converted to one or more other forms that remain in the body of water for extended periods of time. For example, carbon may be consumed by microorganisms and converted into carbon dioxide and/or other biological waste compounds that are immediately dissolved within the water; the dissolved carbon dioxide and/or other materials will migrate to the surface, but it can take hundreds or thousands of years for an appreciable amount to make it to the surface and be emitted from the water into the atmosphere. Both of these paths, and combinations and/or alternatives thereof, provide methods to sequester carbon for extended periods of time.

Turning to FIG. 1A, a mass (or fragment) 10 containing carbon 12 is shown as being disposed in a body of water 20. The mass 10, in selected embodiments, can comprise feedstock that can include a biomass, such as a biomass that originated on land. Biomass that originated in a body of water is also acceptable for use. As shown in FIG. 1A, the mass 10 can have a structure (or matrix) that defines one or more gas pockets or cavities 14 that include air and/or one or more other gasses. The one or more gas pockets or cavities 14 may be of varying size and/or shape, with some being very small, less than one hundred microns in the largest dimension, and integrated into the network of the biological structure. The type, size, and other characteristics of the one or more gas pockets or cavities 14 may be of any form. In some instances, the one or more gas pockets or cavities 14 comprise a biological material that does not have individual identifiable pockets of gas, but instead a low-density structure that is capable of being compressed. For example, that biological material can comprise a mass that occupies a certain volume and that mass occupies a smaller volume after the mass is compressed. In selected embodiments, biomass can comprise a fibrous and/or tubular structure that can serve as channels to deliver water, nutrients, and/or other fluids through the plant.

The body of water 20 can comprise any suitable body of water, including, but not limited to, a body of fresh water and/or a body of salt water, and can define a water surface 22. The mass 10 can be disposed on, or adjacent to, the water surface 22 and can be submerged to a first predetermined depth D₁ below the water surface 22. In selected embodiments, the mass 10 can be permitted to sink to the first predetermined depth D₁, and/or a force can be applied to the mass 10 for sinking the mass 10 to the first predetermined depth D₁. At the first predetermined depth D₁, hydrostatic pressure 24 from the body of water 20 can enter the structure of the mass 10 and compress some or all of the gas pockets 14 of the mass 10. A size, shape and/or other dimension of the mass 10 can decrease as the gas pockets 14 are compressed by first hydrostatic pressure 241 at the first predetermined depth D₁, and/or water from the body of water 20 may displace a portion of the volume occupied gas pockets 14 of the mass 10. Stated somewhat differently, as the gas pockets 14 are compressed, a density of the mass 10 can increase, and/or a buoyancy of the mass 10 can decrease.

The mass 10 with the decreased buoyancy can further sink into the body of water 20. As illustrated in FIG. 1B, for example, the mass 10 can further sink to a second predetermined depth D₂ below the water surface 22. At the second predetermined depth D₂, the hydrostatic pressure 24 from the body of water 20 can increase from the first hydrostatic pressure 241 at the first predetermined depth D₁ to a second hydrostatic pressure 242. The second hydrostatic pressure 242 can enter the structure of the mass 10 and further compress the gas pockets 14 of the mass 10 and/or displace a portion of the volume occupied gas pockets 14 of the mass 10. The size, shape and/or other dimension of the mass 10 can further decrease as the gas pockets 14 are further compressed and/or displaced by the second hydrostatic pressure 242 at the second predetermined depth D₂, and the density of the mass 10 can further increase, and/or the buoyancy of the mass 10 can further decrease.

In some instances, in addition to compression effects on the mass 10, increased pressure may physically disrupt the biological structures within the mass and release gas to the surrounding water. This results in a reduction in the total amount of gases contained within the mass 10 and an associated increase in density.

The mass 10 with the further-decreased buoyancy can continue to sink into the body of water 20. As the mass 10 continues to sink, the hydrostatic pressure 24 from the body of water 20 can continue to increase and to enter the structure of the mass 10. The gas pockets 14 can continue to compress and/or be displaced, and the size, shape and/or other dimension of the mass 10 can continue to decrease as the gas pockets 14 are further compressed, and/or displaced. As the gas pockets 14 continue to be compressed and/or displaced, the density of the mass 10 can continue to increase, and/or the buoyancy of the mass 10 can continue to decrease.

In selected embodiments, the mass 10 can continue to sink until reaching a floor (or seabed) 26 of the body of water 20 as shown in FIG. 1C. The floor 26 of the body of water 20 adjacent to the mass 10 is shown as having a third predetermined depth D₃ below the water surface 22. At the third predetermined depth D₃, the hydrostatic pressure 24 from the body of water 20 can increase to a third or terminal hydrostatic pressure 243. The third hydrostatic pressure 243 can enter the structure of the mass 10, further compressing and/or displacing the gas pockets 14 of the mass 10 and further decreasing the size, shape and/or other dimension of the mass 10.

The system 100 can be configured to discharge the mass 10 into the body of water 20 below a depth at which the hydrostatic pressure from the body of water 20 increases the density of the mass 10 to a value greater than the density of water found within the body of water 20 at the point of injection. Alternatively and/or additionally, the system 100 can be configured to discharge the mass 10 into the body of water 20 below a depth at which the hydrostatic pressure from the body of water 20 increases the density of the mass 10 to a value greater than the maximum density of water found within the body of water 20. The minimum depth below the surface of a body of water at which a mass 10 can be discharged followed by spontaneous sinking of the discharged mass 10 is called the critical submersion depth d_{c}. The critical submersion depth d_{c} can comprise a depth below or otherwise relative to the water surface at which a material must be submerged such that a density of the material is greater than the density of the body of water 20 at the point of injection. The corresponding hydrostatic pressure at the critical submersion depth d_{c} is called critical submersion pressure Pc.

The critical submersion depth d_{c} and the critical submersion pressure Pc are related through Equation 1:

$$d c = Pc / ( ρ * g ) \qquad ( Equation 1 )$$

where, Pc is the critical submersion pressure reported in Pascals (Pa), ρ is the density of water in kg/m\hat{ }3, g is the gravitational constant in m/s\hat{ }2, and d_{c} is the critical submersion depth, in meters. The density of fresh water is near 1,000 kg/m\hat{ }3 and, for practical application, considers only the variation as a function of water temperature and dissolved materials, including salinity. A density of a body of water will increase as the temperature decreases to a maximum at about four degrees Celsius. Typical ocean salt water has a density as high as approximately 1,040 kg/m\hat{ }3. To simply Equation 1, a density of 1,040 kg/m\hat{ }3 is used for salt water applications and a density of 1,000 kg/m\hat{ }3 is used for fresh water application, and a value of 9.8 m/s\hat{ }2 is used as standard approximation for the gravimetric constant, giving Equations 2 and 3.

$$Salt Water {dc}_{( Salt Water )} = Pc / 10 , 200 \qquad ( Equation 2 )$$

$$Fresh Water {dc}_{( Fresh Water )} = Pc / 9 , 800 \qquad ( Equation 3 )$$

Equation 4 is a generalized approximation that introduces an error of two percent or less, but is convenient and easy to remember and calculate without tools. In general, the submersion depth used in practice will be greater than the calculated value by a safety factor, so the generalized equation can be used by experienced operators.

$$Generalized dc = Pc / 10 , 000 \qquad ( Equation 4 )$$

In selected embodiments, the system 100 can operate on a mass 10 with a positive buoyancy. The system 100, for example, can physically push the mass 10 with the positive buoyancy into the body of water 20 and down to the first predetermined depth D₁ (shown in FIG. 1A) below the water surface 22. In the manner set forth above with reference to FIG. 1A, the hydrostatic pressure 24 from the body of water 20 can enter the structure of the mass 10 and compress the gas pockets 14 within the mass 10.

The mass 10, in some cases, may shrink in physical size due to the compression, resulting in a mass 10 with a larger density due to the smaller overall size; while, in other cases, water may displace air pockets so the apparent size can remain unchanged. The density thereby can increase as the gas pockets 14 are compressed, displaced with water, or reduced in mass or volume by other mechanism. Or, a combination may be the result, with some change to the size of the mass 10 and some displacement to water. In selected embodiments, the physical mechanism responsible for increasing the density of the mass 10 is not monitored nor attempted to be defined because the net change in density (and corresponding decrease in buoyancy) is the important result.

To submerge to the bottom or floor of a body of water 20, the positive buoyancy of the mass 10 can be reduced by lowering the mass 10 into the body of water 20 until, at some depth, the buoyancy of the mass 10 is reduced by the increasing hydrostatic pressure 24 from the body of water 20 until the mass 10 becomes negatively buoyant. The mass 10 with the negative buoyancy can continue to sink under its own weight indefinitely, provided that the density of the body of water does not increase dramatically, due to changes in temperature or salinity, for example. In most locations, however, the mass 10 will sink to the bottom of the body of water 20 once the mass 10 becomes negatively buoyant in that body of water 20.

In selected embodiments, the total amount of gas contained within the gas pockets 14 can be maintained within the mass 10 but with a reduced volume. Stated somewhat differently, the gas within the gas pockets 14 may not be evacuated from the mass 10. The gas within the gas pockets 14 thereby can be at a gas pressure that is equivalent to the hydrostatic pressure 24 from the body of water 20 surrounding the mass 10. Additionally and/or alternatively, the gas within the gas pockets 14 can be partially or completely evacuated from the mass 10. In selected embodiments, the total amount of gas contained within the gas pockets 14 can be partially removed by exposing the mass 10 to a pressure lower than that of the atmospheric pressure while the mass 10 is submerged in the body of water 20.

Depending on the level of vacuum (reduced atmospheric pressure) applied to the mass 10, the mass 10 may be negatively buoyant, or the mass 10 may be positively buoyant, but having a shallower (smaller depth) critical submersion depth d_{c} compared to mass 10 that has not been exposed to reduced pressure. After exposing the mass 10 to a reduced atmospheric pressure, a pressure at or above atmospheric is applied while the mass 10 is submerged in water. In some embodiments, the mass 10 may be exposed to more than one cycle of reduced atmospheric pressure followed by atmospheric or greater pressure, while the mass 10 is submerged in water.

The mass 10 can settle on the floor 26 (shown in FIG. 1C) of the body of water 20 in the manner discussed in more detail above with reference to FIG. 1C. The mass 10 can remain on the floor 26 of the body of water 20 indefinitely. The mass 10 may be pushed along the floor 26 of the body of water 20 by water currents where the mass 10 should continue to settle into deeper and deeper water as the mass 10 moves along slopes of the floor 26.

Underwater conditions can vary among different bodies of water 20. For example, conditions in a selected body of water 20, such as deep water, can include cold temperatures and/or a low oxygen concentration. The locations selected to deposit mass 10 will have a floor that is preferably at least two hundred meters below the average surface level, more preferably at least five hundred meters and most preferably at least one thousand meters below the surface, will have water temperatures of less than ten degrees Celsius and most preferably less than four degrees Celsius, and have oxygen concentrations of less than eight milligrams of oxygen dissolved in a liter of water (eight milligrams per Liter of water (mg/L)) and most preferably less than four mg/L, without limitation. Preferably, the location within a selected body of water 20 will be selected based on a low anticipated rate of decay because life forms such as bacteria, worms, and other forms of life that can consume the mass 10 will not survive or thrive. The mass 10 can decay slowly if at all. Preferably, a site is selected based on a low rate of decay where half of the mass 10 is decayed in one hundred years or longer, and more preferably decay time for half of the material is two hundred years or longer. Reported in this manner is called the half-life. Additionally and/or alternatively, a sunken mass 10 is not considered a pollutant by any known rating system and can be a safe way to store large quantities of carbon for extended periods of time.

The system 100 can increase the density of the fragments 10 in any suitable manner. Exemplary manners for increasing the density of the fragments 10 within the carbon-containing material can include reducing a size of the low-density gas pockets 14 within the fragments 10 and/or extracting gas from the low-density gas pockets 14 within the fragments 10. The density of the fragments 10 preferably is increased while the fragments 10 are surrounded by a liquid, such as the body of water 20 in which the material is to be submerged.

In selected embodiments, a portion of the gas contained within the gas pockets 14 of the fragment 10 of the biomass material can be removed by subjecting the fragment 10 of biomass material to a vacuum or other reduced pressure that is less than atmospheric pressure. Subjecting the fragments 10 to reduced atmospheric pressure can also reduce the amount of surface-gases found on a fragment 10 when submerged. Air and/or other gases may be attached to a submerged surface in the form of bubbles and/or surface layer or layers, due to surface tension of the surrounding water, surface topography, and/or other factors. In one embodiment, reduced pressure is drawn onto the fragments while the fragments 10 are submerged in the body of water 20. By applying the reduced pressure while the fragment 10 of biomass material is submerged in the body of water 20, gas can be inhibited from refilling the gas pockets 14 when the reduced pressure is removed and pressure surrounding to the fragment 10 returns to atmospheric (or near atmospheric pressure or greater than atmospheric pressure). Preferably, the fragment 10 of biomass material is not exposed to atmospheric while subjected to reduced pressure. In an alternate embodiment, reduced pressure is drawn onto the fragments while the fragments 10 are held within an air-tight vessel, without filling the vessel with water. After the desired level of vacuum is achieved within the vessel, a valve is opened to allow water from the body of water 20, or another source, to fill the vessel.

Subjecting the fragment 10 of biomass material to a vacuum or other reduced pressure followed by returning the fragment 10 of biomass material to atmospheric pressure while being submerged is typically an irreversible process. This is because gas from the gas pockets 14 is physically removed from the fragment 10 of biomass material and replaced with water during the process. As a result, fragment 10 of biomass material treated with reduced pressures can be handled outside of the body of water and loaded into a split-hull barge, for example. Some atmospheric air may enter the fragment 10 of biomass material during handling, but typically the quantity is small. When the fragment 10 of biomass material is processed in this manner, it may be advantageous to treat the fragment 10 of biomass material with a level of vacuum greater than that required if the fragment 10 of biomass material remain submerged after processing, but this handling method may be the most efficient. In some embodiments, the mass 10 may be exposed to more than one cycle of reduced atmospheric pressure followed by atmospheric or greater pressure, while the mass 10 is submerged in water, thus reducing the required level of vacuum required for processing.

In one embodiment, a portion of the gas contained within the gas pockets 14 of the fragment 10 of biomass material is removed by subjecting the fragment 10 of biomass material to a vacuum of seven hundred millimeters of mercury below atmospheric pressure, followed by a return to atmospheric pressure, while the fragment 10 of biomass is fully submerged below water for the entire process. The treated fragment 10 of biomass then can be removed from the water (stated somewhat differently, treated fragment 10 of biomass is no longer submerged at this point) and loaded onto a split hopper barge and sailed to a point in a body of water where submersion is desired. At this time, the split hopper barge is opened and the treated fragment 10 of biomass enters the water and sinks to the bottom of the body of water.

Additionally, and/or alternatively, the gas pockets 14 within the fragment 10 of biomass material can be reduced in total volume by subjecting the biomass fragment 10 to an increased pressure while being submerged under water. Applying pressure, such as the hydrostatic pressure 24 from the body of water 20 and/or a high pressure pump, while the fragment 10 is below the water surface 22 of the body of water 20 can reduce the size, shape and/or other dimension of the gas pockets 14 and increase a density of the fragment 10. Application of the pressure can break some of the structure of the fragment 10 of biomass material and/or eliminate one or more of the gas pockets 14. In selected embodiments, water can enter and, in some cases, partially or completely fill at least one of the gas pockets 14. To operate efficiently, applying as low of a pressure as possible to the fragment 10 of biomass material to achieve a predetermined fragment density is desirous. In some embodiments, pressure is applied and returned to atmospheric (or reduced atmospheric pressure) and then applied again. Repeated cycles can lower the amount of pressure needed to achieve a predetermined fragment density.

The system 100 advantageously can be capable of submerging a wide range of materials, in a manner that is efficient and low cost, thereby enabling the storage of large quantities of carbon. An ability to acquire large quantities of feedstock material can enable significant mass of carbon to be sequestered. An exemplary source of large quantities of carbon-containing material is biomass, and biomass is a preferred material. In the broadest sense, biomass can include any type of plant material. In a preferred embodiment, material can include land-derived carbon-containing material (or biomass). Land-derived biomass includes many specific species. Preferably, the material for submerging comprises a compound with at least ten percent carbon content by weight measured on a dry basis.

In some embodiments, the feedstock material is first processed to produce a uniform feedstock. Although any feedstock is suitable for use with the system 100 and may be submerged, large tree trunks, branches, and other large or extended structures can be difficult to process in an efficient manner. Additionally, large biomass structure may take extended periods of time or higher depths/pressures to successfully modify the structure to increase density. Therefore, it is preferred to reduce the side of biomass using equipment such as wood chippers, hammer mills, and other common equipment that reduces the size of biomass. Preferably, the biomass is processed in size-reducing equipment, such as a wood-chipper, hammer mill, vibratory mill, or other equipment. Size reduction equipment typically produces fragments with a distribution of sizes, and does not typically produce identically-sized fragments. Size separation equipment can be used to separate fragments of different sizes. Preferably, the largest fragments used for submersion will have a mass of less than five hundred grams, and more preferably reduced to fragments with a mass of less than one hundred grams, and most preferably to fragments with a mass of less than fifty grams.

Reducing the size of the biomass allows for a reduction in the amount of time and/or the critical submersion depth/pressure to sink the biomass by increasing the availability of the internal features that are modified to increase the density, as described above. For many types of biomass, one or more gas pockets or cavities 14 that include air and/or one or more other gasses can be defined within the structure (or matrix) of the biomass material. Reducing the size, shape and/or other dimension of the fragment 10 can provide access to an increased number of gas pockets 14 within a given mass of the biomass material. Some gas pockets 14 can exist at a micron-scale and/or can be difficult to access. Reducing the fragment 10 to a fine particulate may provide greater access to the biomass material, but such a reduction may require additional time and/or equipment to process. In selected Preferably, a minimum amount of energy and/or time is invested into processing the biomass material to increase the density of the biomass fragment

After the biomass is reduced in size, the material may be processed through equipment to sort or classify the produced fragments into suitably uniformly sized pieces. Sorting materials into similarly sized fragments is an optional step that may improve overall efficiency. For example, screening separators may be used to separate fragments above or below a predetermined size. Vibratory screening equipment improves the amount of mass that can be processed. Vibratory screening equipment is one method that is preferably used. This equipment uses wire mesh to allow pieces smaller than the mesh size to pass through the screen and retain larger pieces. Multiple screens can produce “cuts” of material, with each having a similar size to others retained or rejected by a given screen.

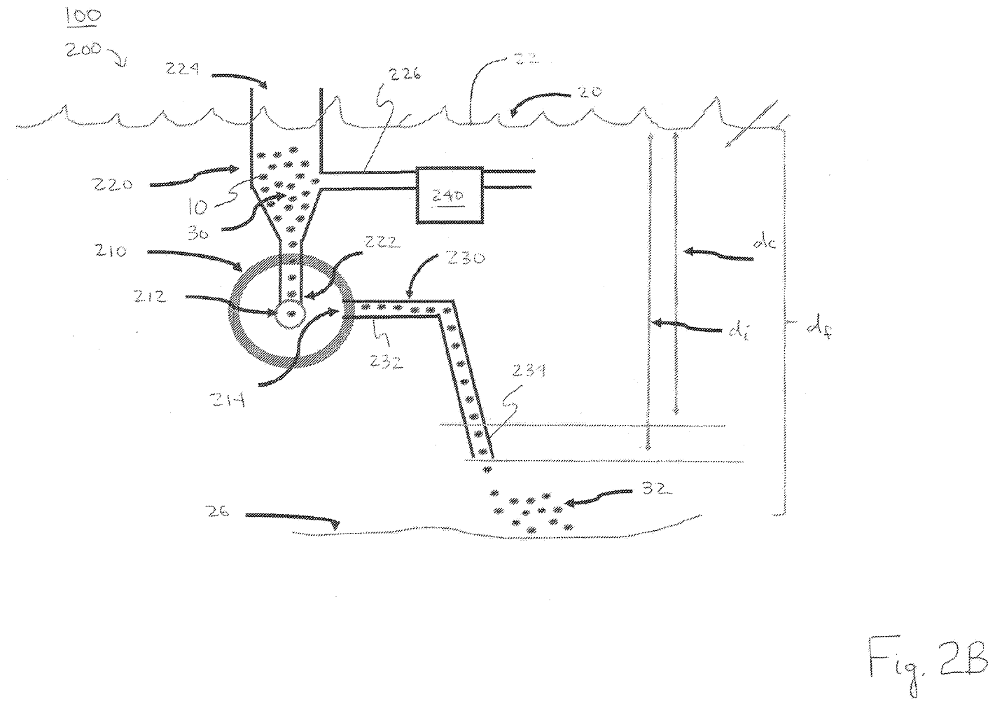

Turning to FIG. 2A, a system 100 for submerging biomass materials is shown as being configured for depositing the materials at or near the floor 26 of the body of water 20. Stated somewhat differently, the system 100 can comprise a carbon-containing material submersion system 200 for submerging biomass or other carbon-containing materials. The material submersion system 200 is shown as including a pump system 210. In selected embodiments, the pump system 210 can comprise a dredging pump or any other type of pump that is capable of moving solid matter. Preferably, the pump is designed to move solid materials. The pump system 210 can include a pump inlet port 212 and a pump outlet port 214.

The carbon-containing material submersion system 200 likewise can include a hopper system 220, such as a feedstock hopper system, that can communicate with the pump system 210. The hopper system 220 can include a hopper loading section 224 into which feedstock that can include a biomass and/or other material (collectively, feedstock 30) can be loaded and a hopper system outlet 222. Various feedstocks 30 can be used, including agricultural residues such as walnut shells, peach and olive pits, tree thinning such as pine pellets and wood shavings, and/or water-based plants such as water hyacinth, without limitation.

In selected embodiments, the feedstock 30 can include one or more masses (or fragments) 10 containing carbon 12 in the manner discussed in more detail herein with reference to FIGS. 1A-C. As shown in FIG. 2A, the hopper system outlet 222 can be connected with the pump inlet port 212 of the pump system 210. The hopper system 220 thereby can deliver the loaded material to the pump system 210. The pump system 210 can receive fragments 10 comprising the feedstock 30 from the hopper system 220 and can pump the fragments 10.

The feedstock 30 can be loaded into the hopper system 220 in any suitable manner. For example, a front-end loader system (not shown) can be used to drop feedstock 30 into the hopper system 220 via the hopper loading section 224 and/or a conveyor system (not shown) may be configured to deliver the feedstock 30 into the hopper system 220. The conveyor system can comprise at least one track segment for conveying the feedstock 30 into the hopper system 220.

In selected embodiments, the system 100 optionally can include a control system (or circuit) (not shown) for helping to control a mass of the feedstock 30 being loaded into the hopper system 220. The mass of feedstock 30 can be loaded into the hopper system 220, for example, via the conveyor system capable of determining the mass of feedstock 30 on one or more specific track segments of the conveyor system.

In selected embodiments, the control system can determine the mass of feedstock 30 on a selected track segment of the conveyor system. A motor control system (or circuit) (not shown) can increase and/or decrease a speed of the conveyor system and/or can be separate from, or at least partially integrated with the control system. In other words, the motor control system can be incorporated with the control system in whole and/or in part.

The motor control system advantageously can be configured for delivering a predetermined mass of the feedstock 30 to the pump system 210 during a predetermined period of time. For example, the predetermined mass of the feedstock 30 delivered to the pump system 210 each minute can comprise a target value and a low and high tolerance allowance. For example, the target may be one thousand kilograms and a tolerance of 100 kilograms so that between nine hundred kilograms and one eleven hundred kilograms of feedstock 30 is allowable to maintain smooth operation. One or more load cell systems (or circuits) (not shown) can be installed to measure the mass of the feedstock 30 on each two-meter track segment of the conveyor system.

Water, preferably from the body of water 20, can be delivered to the pump system 210 and can serve as a working fluid to operate the pump system 210. For example, the water can be delivered to the hopper system 220 via a water inlet port 226 of the hopper system 220, and/or water may be delivered into to the hopper system 220 through the hopper loading section 224. In selected embodiments, the water can be supplied from the body of water 20 via a water feed pump system (not shown), a gravity feed, and/or in any other suitable manner. A ratio of an amount of water to an amount of feedstock 30 supplied optionally can be controlled via controls equipment (not shown).

A discharge pipe system 230 is illustrated as having a proximal end region 232 that can be connected to the pump outlet port 214. The discharge pipe system 230 can be configured to receive the feedstock 30 and water mixture that is provided by the hopper system 220 via the pump system 210. A distal end region 234 of the discharge pipe system 230 can enter the body of water 20 at a discharge pipe entry point 22A at the water surface 22. The distal end region 234 of the discharge pipe system 230 can extend below the water surface 22 to a predetermined injection depth dᵢ below or otherwise relative to the water surface 22. In selected embodiments, the discharge pipe system 230 can terminate at the predetermined injection depth dᵢ. The discharge pipe system 230, in other words, can lead to a predetermined injection depth dᵢ and/or a predetermined location within the body of water 20.

The feedstock 30 can flow through the discharge pipe system 230 from the proximal end region 232 to the distal end region 234. While flowing through the discharge pipe system 230, the feedstock 30 can be transformed into masses (or fragments) 10, or processed fragments 32, that have a density that is greater than a density the body of water 20 at the predetermined injection depth dᵢ. In selected embodiments, the fragments 32 are small enough to pass through the pump system 210 and the discharge pipe system 230. The dense processed fragments 32 therefore can exit the distal end region 234 of the discharge pipe system 230 and sink. In selected embodiments, the density of the dense processed fragments 32 can be greater than the density of the body of water 20 at any depth and can sink to the floor 26 of the body of water 20. The floor 26 of the body of water 20 can be associated with a predetermined floor depth d_{c} that is equal to a distance between the water surface 22 and the floor 26 of the body of water 20.

Preferably, the predetermined injection depth dᵢ can be below the critical submersion depth d_{c} so that the processed fragments 32 will sink to, or near to, the bottom of the body of water 20. Here, the critical submersion depth d_{c} can depend on one or more characteristics of the feedstock 30, including a material type, an age, a moisture content, a fragment size, and other factors, without limitation.

Preferably, the predetermined injection depth dᵢ can be below a critical floor submersion depth (not shown). The critical floor submersion depth can comprise a depth below the water surface 22 at which a material must be submerged such that a density of the material is greater than the density of the body of water 20 through all layers, from the point of injection to the bottom of the body of water 20. Typically, the critical floor submersion depth is equal to the critical submersion depth d_{c} because the density of the material increases as the material sinks lower into the body of water 20 and the increases in density of the body of water 20 due to temperature and/or salinity are not as great as the increases in density of the sinking material. In some cases, however, the critical floor submersion depth may be greater than the critical submersion depth because the density of water can vary within the body of water 20. The water density can vary because the density of water has a maximum value near four degrees Celsius. For the dense processed fragments 32 to reach the floor 26 of the body of water 20, the carbon-containing material submersion system 200 can subject the feedstock 30 to a pressure that is greater than the critical floor submersion depth for the body of water 20 so that the dense processed fragments 32 sink to the floor 26 of the body of water 20 after discharge from the distal end region 234 of the discharge pipe system 230.

An alternative embodiment of the carbon-containing material submersion system 200 is shown in FIG. 2B. The carbon-containing material submersion system 200, for example, is illustrated as being at least partially submerged below the water surface 22 of the body of water 20. Stated somewhat differently, one or more of the pump system 210, the hopper system 220 and/or the discharge pipe system 230 can be submerged in whole and/or in part. Turning to FIG. 2B, for example, the hopper system 220 is shown as being partially submerged below the water surface 22 of the body of water 20; whereas, the pump system 210 and the discharge pipe system 230 are completely submerged below the water surface 22. By at least partially submerging the carbon-containing material submersion system 200, water for the pump system 210 advantageously can be delivered via gravity feed and/or controlled by a flow control system (or circuit) 240.

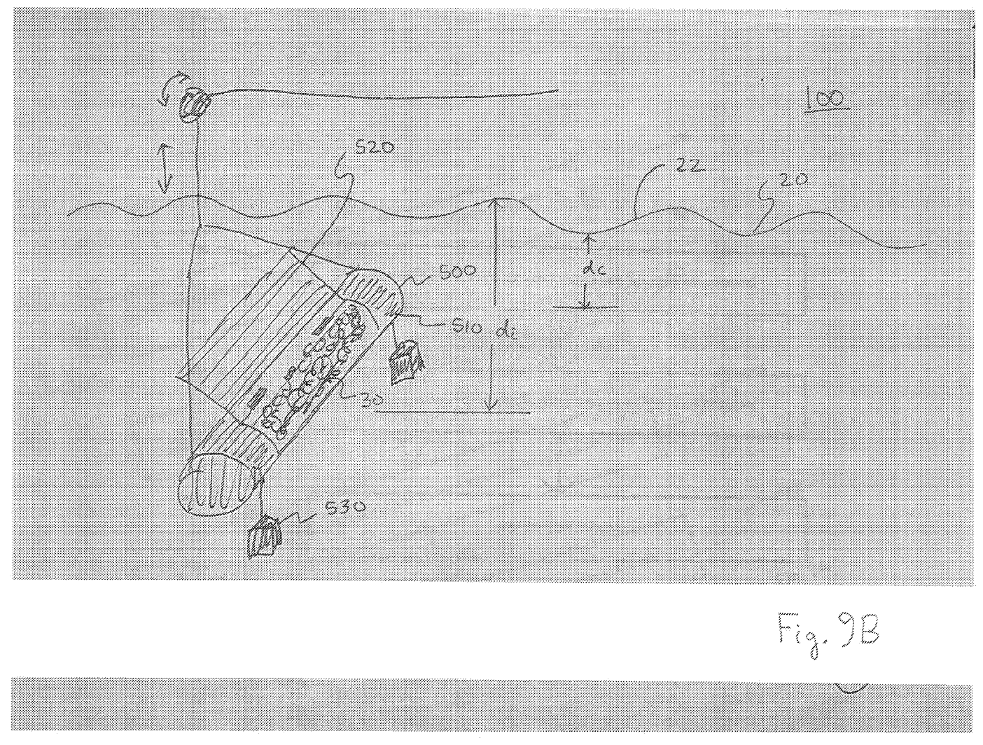

Additionally and/or alternatively, the system 100 can comprise a water permeable vessel 500 as illustrated in FIGS. 9A-B. Feedstock 30 can be disposed within the vessel 500. For example, the vessel 500 may be comprised of steel mesh 510 such that water readily passes through the mesh 510 from one side to the other with one or more openable portions 520 for allowing convenient loading and unloading of the feedstock 30. The mesh 510 can have any suitable size, shape or other dimension for containing the feedstock 30, while allowing permeability of water. The vessel 500 with the feedstock 30 can be lowered to a predetermined injection depth dᵢ below or otherwise relative to the water surface 22 of the body of water 20. The predetermined injection depth dᵢ preferably is greater (or deeper) than the critical submersion depth d_{c} of the feedstock 30. Upon being lowered to the predetermined injection depth dᵢ, the feedstock 30 can be released from the vessel 500.

Such a vessel 500 can be easy to operate in large scales and/or can be raised and/or lowered into the body of water 20 using a crane (not shown) or other common hoisting mechanism. Additionally and/or alternatively, the vessel 500 may also be fitted with one or more ballast tanks and/or weights 530 to improve a rate at which the vessel 500 can be raised and/or lowered. The system 100 optionally can include a submersible camera (not shown) such that one or more crew members (not shown) can monitor a status of the feedstock 30 disposed within the vessel 500.

When the vessel 500 is near the surface of the body of water 20, the feedstock 30 can be positively buoyant and be located near an upper portion of the vessel 500. As the vessel 500 is lowered into the body of water 20, the feedstock 30 including internal gas pockets 14 (shown in FIGS. 1A-C) can equilibrate with hydrostatic pressure at a depth of the body of water 20 surrounding the vessel 500. A pressure applied to the feedstock 300 can become equivalent in pressure to that hydrostatic pressure and can partially or fully collapse some or all of the gas pockets 14. As the vessel 500 reaches the critical submersion depth d_{c}, the feedstock 30 can become negatively buoyant and can fall to a lower portion of the vessel 500 at which point the crew can note the crossing of the critical submersion depth d_{c}, and readiness for release of the feedstock 30 into the body of water 20. The rate at which the vessel 500 is lowered into the body of water 20 and/or under water currents may impact the location of the feedstock 30 within the vessel 500 and can be accounted for during the operation.

In another embodiment, a pressure vessel (not shown) comprising a vertical cylindrical body with one or more openable portions at upper and lower portions of the cylindrical body to allow convenient loading and unloading of feedstock 30. Operating vertically in the body of water 20, the upper portion of the cylindrical body can be opened to dispose feedstock 30 within the vessel. A remaining portion of the cylindrical body can be filled with water from the body of water 20, and the cylindrical body can be closed to seal. The pressure vessel can be partially evacuated of air and/or other gasses to a predetermined level of vacuum and then re-equilibrated with atmospheric pressure while the feedstock 30 remains surrounded by water. The treated feedstock 30 can then be discharged from a bottom opening portion of the cylindrical body below the water surface 22 of the body of water 20. In one embodiment the pressure vessel can remain generally fixed in position with the openable top at or near the water surface.

Alternatively, the pressure vessel with the feedstock 30 can be lowered to a predetermined depth below or otherwise relative to the water surface 22 prior to discharging the treated feedstock 30. Preferably, the treated feedstock 30 has a density greater than a density of the body of water 20. If the density of the treated feedstock 30 is not greater than the density of the body of water 20, the pressure vessel advantageously can be lowered to a predetermined depth prior to discharge. The predetermined depth preferably is greater (or deeper) than the critical submersion depth d_{c} of the treated feedstock 30, which generally will be at a depth that is not as deep as the feedstock 30 prior to vacuum treatment because the vacuum treatment should remove at least some internal gases. Upon being lowered to the predetermined depth, the feedstock 30 can be released from the pressure vessel.

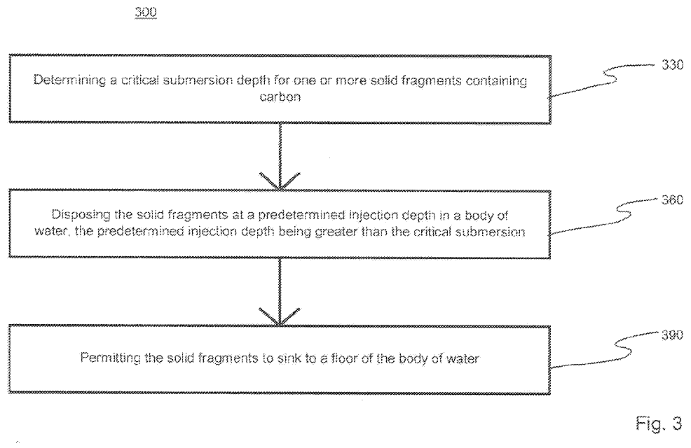

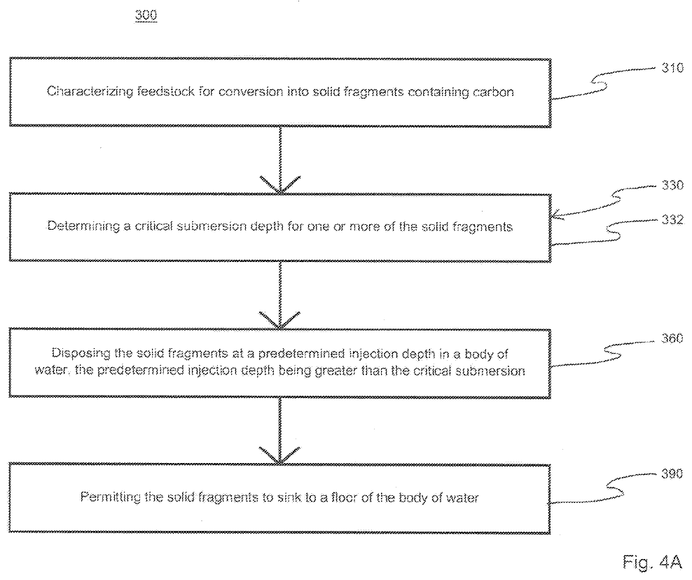

The carbon-containing material submersion system 200 can create the submerged carbon-containing material in any suitable manner. An exemplary method 300 for creating the submerged carbon-containing material is illustrated in FIG. 3. The method 300, in other words, can comprise a method for submerging biomass materials. In selected embodiments, the method 300 can be performed via the carbon-containing material submersion system 200 (shown in FIGS. 2A-B) to create the submerged carbon-containing material. The present disclosure also extends to a product comprising carbon formed pursuant to the carbon-containing material submersion system 200.

Turning to FIG. 3, the method 300 is shown as including, at 330, determining a critical submersion depth d_{c} (shown in FIGS. 2A-B) for one or more masses (or fragments) 10 containing carbon 12 (shown in FIGS. 1A-C). The critical submersion depth d_{c} can comprise a depth below or otherwise relative to a water surface 22 (shown in FIGS. 2A-B) of a body of water 20 at which the fragments 10 must be submerged such that a density of the fragments 10 is greater than the density of the body of water 20. In the manner discussed in more detail above with reference to FIGS. 1A-C, the fragments 10 can have a structure (or matrix) that defines one or more gas pockets or cavities 14 (shown in FIGS. 1A-C) that include air and/or one or more other gasses.

The method 300 can include, at 360, disposing the fragments 10 at a predetermined injection depth dᵢ (shown in FIGS. 2A-B) below or otherwise relative to the water surface 22 of the body of water 20. The predetermined injection depth dᵢ preferably is greater (or deeper) than the critical submersion depth d_{c}. Preferably, predetermined injection depth dᵢ results in the fragments 10 sinking to the bottom of the body of water 20. Once disposed in the body of water 20, the fragments 10 can be permitted to sink, at 390, to a floor (or seabed) 26 (shown in FIG. 1C) of the body of water 20. The floor 26 (shown in FIGS. 2A-B) of the body of water 20 can be associated with a predetermined floor depth d_{f} below or otherwise relative to the water surface 22 of the body of water 20. Stated somewhat differently, the predetermined floor depth d_{f} can be equal to a distance between the water surface 22 and the floor 26 of the body of water 20. The present disclosure also extends to a product comprising carbon formed pursuant to the method 300.

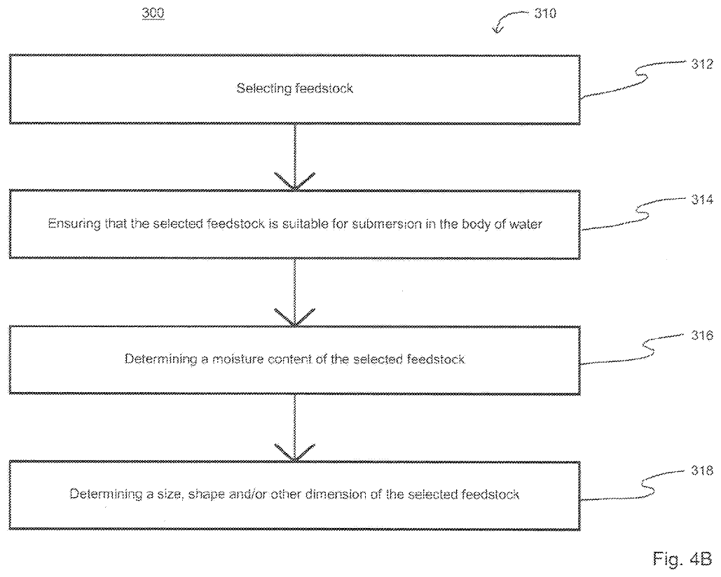

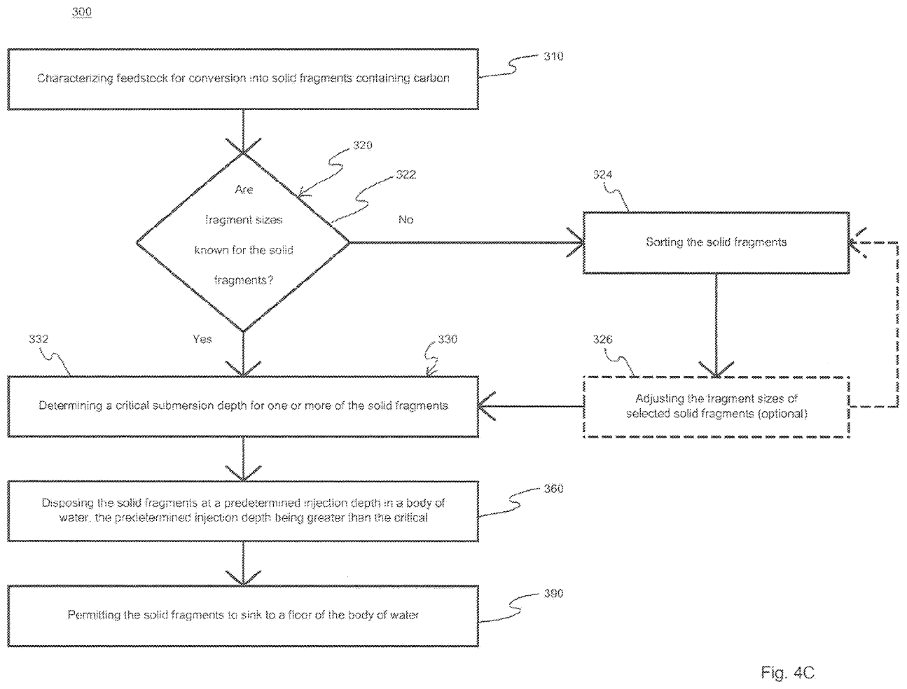

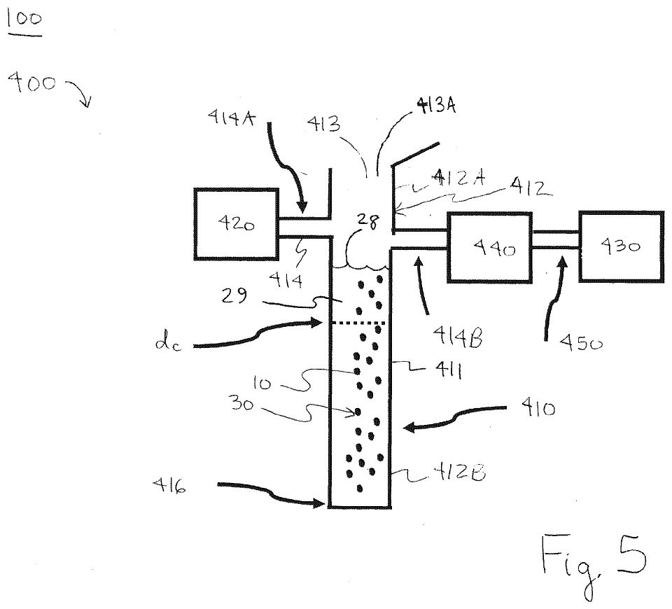

The fragments 10, in selected embodiments, can comprise the feedstock 30 (shown in FIGS. 2A-B), which can include biomass. As shown in FIG. 4A, the method 300 optionally can include characterizing the feedstock 30 for conversion into the fragments 10, at 310. The critical submersion depth d_{c} for the fragments 10 can be determined at, 332, in the manner discussed in more detail herein.

The method 300 optionally can include one or more initialization steps. The method 300, for example, can be initialized by characterizing the feedstock 30 for conversion into the fragments 10. The feedstock 30 can be characterized for conversion into the fragments 10 in any suitable manner. In selected embodiments, the feedstock 30 can be characterized based upon one or more characteristics, such as a type, a size and/or a moisture content of the feedstock 30, without limitation. An exemplary manner for characterizing the feedstock 30 for conversion into the fragments 10 is illustrated in FIG. 4B.

Turning to FIG. 4B, the feedstock 30 can be selected, at 312. Additionally and/or alternatively, the method 300 can include ensuring that the selected feedstock 30 is suitable for submersion in the body of water 20, at 314. A moisture content of the selected feedstock 30 can be determined, at 316. The moisture content can be determined, at 316, before and/or after the suitability for submersion of the selected feedstock 30 is determined, at 314. Advantageously, the determination of the moisture content, at 316, can assist in a determination of a mass of submerged carbon associated with the selected feedstock 30.

The method 300 can include, at 318, determining a size, shape and/or other dimension of the selected feedstock 30. The determination of the size, shape and/or other dimension of the selected feedstock 30, at 318, can be made in any suitable manner. An exemplary manner for determining the size, shape and/or other dimension of the selected feedstock 30, at 318, can comprise passing the selected feedstock 30 over a screen (not shown), without limitation. The screen can define one or more openings with opening sizes, shapes and/or other dimensions that are equal to a predetermined size, shape and/or other dimension of a largest desired fragment suable for use.

Optionally vibrating the screen can increase a throughput of characterizing the selected feedstock 30. Oversized fragments 10 can remain on top of the screen and can be removed, set-aside and/or further processed; while, the fragments 10 that are suitable in size, shape and/or other dimension can pass through the openings in the screen. For materials with a high aspect ratio, a set of two or more screens can be utilized, as high aspect fragments 10 may pass through a single screen. In one embodiment, the size of the fragments 10 are chosen based on the size allowable for use in the pumping equipment selected for use to pump the fragments into the body of water 20. The largest size fragments 10 that are compatible with the pumping equipment are generally desired for use to maximize material throughput.

The determination of the size, shape and/or other dimension of the selected feedstock 30, at 318, advantageously can aid in a determination of whether the size, shape and/or other dimension of the selected feedstock 30 is within a suitable range of fragment sizes, shapes and/or dimensions for use. Stated somewhat differently, the size, shape and/or other dimension of the selected feedstock 30 determined, at 318, can help determine of whether a reduction in the size, shape and/or other dimension of the selected feedstock 30 is needed.

As shown in FIG. 4C, the method 300, for example, can include a determination, at 320, about whether a reduction in the size, shape and/or other dimension of the selected feedstock 30 is needed. The method 300, in other words, can prepare the selected feedstock 30 for submersion. The determination, at 320, for example, can comprise a determination about whether fragment sizes, shapes and/or other dimensions are known for the fragments 10, at 322. If the fragment sizes, shapes and/or other dimensions are known for the fragments 10, the critical submersion depth d_{c} for the fragments 10 can be determined at, 332. The critical submersion depth d_{c} varies, in some biomasses, as a function of the fragment size. Fragments of various sizes may be produced in small batches and grouped into similar sizes for further testing. In one embodiment, fragments of each predetermined size class tested in the submersion characteristics test apparatus 400 as shown in FIG. 5 (the operation of which is described herein) to determine the critical submersion depth d_{c} for each size fragments. The operators would then determine the best fragment size or sizes based on the required processing time, pump throughput, energy requirements and other factors.

Otherwise, the fragments 10 can be sorted, at 324. The fragments 10, for instance, can be sorted, at 324, into two or more fragment groups. Exemplary fragment groups can include, for example, a first fragment group that comprises fragments 10 with fragment sizes, shapes and/or dimensions that are less than a predetermined fragment size, shape and/or dimension, and a second fragment group that comprises fragments 10 with fragment sizes, shapes and/or dimensions that are greater than the predetermined fragment size, shape and/or dimension.

The fragments 10 can be sorted, at 324, can be sorted in any suitable manner. An exemplary manner for sorting the fragments 10, at 324, can comprise passing the fragments 10 included in the feedstock 30 over a screen (not shown), without limitation. The screen can define one or more openings with opening sizes, shapes and/or other dimensions that are equal to a predetermined size, shape and/or other dimension of a largest desired fragment suable for use. Optionally vibrating the screen can increase a throughput of characterizing the fragments 10. Oversized fragments 10 can remain on top of the screen and can be removed, set-aside and/or further processed; while, the fragments 10 that are suitable in size, shape and/or other dimension can pass through the openings in the screen. For materials with a high aspect ratio, a set of two or more screens can be utilized, as high aspect fragments 10 may pass through a single screen.

In the manner set forth above, for example, the fragments 10 optionally can be further processed based upon the fragment groups. The method 300, for example, can include adjusting fragment sizes, shapes and/or other dimensions of selected fragments 10, at 326, as needed. The fragment sizes, shapes and/or other dimensions of selected fragments 10 can be adjusted, at 326, such that the fragment sizes, shapes and/or other dimensions are within a predetermined range of sizes, shapes and/or other dimensions. When the fragment sizes, shapes and/or other dimensions are within the predetermined range of sizes, shapes and/or other dimensions, the critical submersion depth d_{c} for the selected fragments 10 can be determined at, 332, in the manner discussed in more detail herein.

In selected embodiments, the selected fragments 10 can have fragment sizes, shapes and/or other dimensions that are greater than the predetermined size, shape and/or other dimension of a largest desired fragment suable for use, and the fragment sizes, shapes and/or other dimensions of these selected fragments 10 can be reduced. Stated somewhat differently, the fragment sizes, shapes and/or other dimensions of oversized fragments 10 can be reduced. The fragment sizes, shapes and/or other dimensions of the selected fragments 10 can be reduced, for example, via efficient equipment, such as hammer mills. After the fragment sizes, shapes and/or other dimensions have been reduced, the critical submersion depth d_{c} for the selected fragments 10 with the reduced fragment sizes, shapes and/or other dimensions can be determined at, 332, in the manner discussed in more detail herein.

Additionally and/or alternatively, one or more of the selected fragments 10 with the reduced fragment sizes, shapes and/or other dimensions optionally can be sorted, at 324. The one or more selected fragments 10 with the reduced fragment sizes, shapes and/or other dimensions, in other words, can again be sorted, at 324, to help ensure that each selected fragments 10 is within the suitable range of fragment sizes, shapes and/or dimensions for use. Stated somewhat differently, the selected fragments 10 optionally can be repeatedly sorted, at 324, and undergo the size, shape and/or other dimension adjustment, at 326. Oversize fragments 10 may damage and/or clog the pump system 210 (shown in FIGS. 2A-B) and/or clog the hopper system 220 (shown in FIGS. 2A-B) and/or the discharge pipe system 230 (shown in FIGS. 2A-B).

Although small fragments 10, such as saw and method dust, leaf residue, and other small particulate matter may be submerged successfully, the small sizes, shapes and/or dimensions of such small fragments 10 may lead to clogging of the pump system 210, the clog hopper system 220 and/or the discharge pipe system 230. Additionally and/or alternatively, the small fragments 10 may be easily caught in under-surface water currents and drift to undesired locations. Accordingly, in selected embodiments, adjusting fragment sizes, shapes and/or other dimensions of selected fragments 10, at 326, can include increasing the fragment sizes, shapes and/or dimensions of the fragments 10. An exemplary manner for increasing the fragment sizes, shapes and/or dimensions of the fragments 10 can include, but is not limited to, pressing the fragments 10 into pellets with a pelletizing machine or other suitable system. Binding the fine material together with adhesives, binders, glue and other materials, preferably plant based materials, is another means to increase size.

In selected embodiments, one or more of the selected fragments 10 with the increased fragment sizes, shapes and/or other dimensions optionally can be sorted, at 324. The one or more selected fragments 10 with the increased fragment sizes, shapes and/or other dimensions, in other words, can again be sorted, at 324, to help ensure that each selected fragments 10 is within the suitable range of fragment sizes, shapes and/or dimensions for use. Stated somewhat differently, the selected fragments 10 optionally can be repeatedly sorted, at 324, and undergo the size, shape and/or other dimension adjustment, at 326. After the fragment sizes, shapes and/or other dimensions have been decreased, the critical submersion depth d_{c} for the selected fragments 10 with the increased fragment sizes, shapes and/or other dimensions can be determined at, 332, in the manner discussed in more detail herein.

The critical submersion depth d_{c} for the selected fragments 10 can be determined, at 332, in any suitable manner. In selected embodiments, the critical submersion depth d_{c} can be determined via a submersion characteristics test apparatus 400 as shown in FIG. 5. The submersion characteristics test apparatus 400 advantageously can be configured for submerging the selected fragments 10 during operations to create submerged carbon-containing material and/or for testing one or more characteristics of the selected fragments 10.

Turning to FIG. 5, the exemplary submersion characteristics test apparatus 400 can include a pressure vessel 410. The pressure vessel 410 can comprise an elongated body 411 that includes opposite end regions 412 and that defines an internal channel 413. A first (or upper) end region 412A of the pressure vessel 410 can comprise an open end region that can define an opening 413A in communication with the internal channel 413. The feedstock 30, including the mass (or fragments) 10, can be disposed in the internal channel 413 of the pressure vessel 410 via the opening 413A. In selected embodiments, the first end region 412A can comprise a hinged end region or other design for permitting rapid access to the internal channel 413 of the pressure vessel 410. The first end region 412A of the pressure vessel 410, for example, can alternate between a first (or open) operational state for permitting access to the internal channel 413 via the opening 413A and a second (or closed) operational state for inhibiting access to the internal channel 413 via the opening 413A. In other words, the first end region 412A can comprise an open end region in the first operational state and a closed end region in the second operational state.

A second (or lower) end region 412B of the pressure vessel 410 can comprise a closed end region. In other words, the second end region 412B can inhibit communication with the internal channel 413 of the pressure vessel 410. An end cap 416, for example, can be disposed at the second end region 412B of the pressure vessel 410. The end cap 416 can be permanently installed at the second end region 412B or may be selectably removable to allow cleaning or other access to the internal channel 413 of the pressure vessel 410. In selected embodiments, the elongated body 411 can be formed from a transparent material for allowing visual determination of a depth or other location of feedstock fragments 10 within the pressure vessel 410.

As illustrated in FIG. 5, the submersion characteristics test apparatus 400 can include one or more access ports 414. At least one of the access ports 414 can be in communication with the internal channel 413 of the pressure vessel 410. Exemplary access ports 414 can include, but are not limited to, a pressure sensing port 414A and/or a pressure control port 414B. The pressure sensing port 414A can be mechanically fixed to the pressure vessel 410 and/or can be coupled with a pressure sensor system (or circuit) 420 for determining an internal pressure inside of the pressure vessel 410.

The pressure control port 414B can be mechanically fixed to the pressure vessel 410 and/or can allow fluid exchange between a fluid pressure source 430 and the pressure vessel 410. The fluid pressure source 430 and the pressure vessel 410 can be coupled directly and/or coupled indirectly via one or more intermediate components. A metering valve system 440, for example, can be disposed between the fluid pressure source 430 and the pressure vessel 410 via valve piping 450. The valve piping 450 can be configured for allowing controlled amounts of fluid to be exchanged between the pressure vessel 410 and fluid pressure source 430.

Connections to the pressure vessel 410 can reduce a pressure rating of the pressure vessel 410 and should be considered such that an overall pressure rating of the submersion characteristics test apparatus 400 is sufficient to allow testing to expected depth levels, such as the critical submersion depth d_{c} for the fragments 10. Exemplary connections to the pressure vessel 410 can include a lid, a gas supply, a gauge and/or any other ports 412 or other features of the pressure vessel 410. Materials that can be used for the pressure vessel 410 can include, but are not limited to, a Lexan® material available from the General Electric Company in Pittsfield, Massachusetts, or any other polycarbonate material.

### Operation of Submersion Characteristics Test Apparatus 400

In some embodiments, the test apparatus 400 as shown in FIG. 5 can be used to determine the critical submersion pressure Pc and thus the critical submersion depth d_{c} as described below. Further, in another embodiment, the test apparatus 400 as shown in FIG. 5 can be used to determine a critical level of vacuum Vc. The methods used to determine the critical submersion pressure Pc and thus the critical submersion depth d_{c}, and the critical level of vacuum Vc advantageously can employ the principles similar to those used to sink materials in larger volumes.

### Method 1: Application of Positive Pressure

When submerging mass (or fragments) 10 by sinking to a depth that initiates spontaneous sinking, such as the critical submersion depth d_{c}, (in other words, sinking the mass (or fragments) 10 to a depth where the mass (or fragments) 10 have a density greater than that of the surrounding water), the following method can be employed.

The test apparatus 400 can be configured to the first (or open) operational state for permitting access to the internal channel 413 via the opening 413A. Next, mass (or fragments) 10 can be loaded into the internal channel 413 via the opening 413A and filled to between ten percent and twenty percent of the height of the internal channel 413, and then water, preferably from the body of water 20, is used to fill the internal channel 413 to between eighty percent and one hundred percent of full capacity of the internal channel 413. The test apparatus preferably has a suitably large diameter such that the mass (or fragments) 10 do not bind up together and/or against the wall of the test apparatus 400 when filled with water. The mass (or fragments) 10 should be able to move around freely. Preferably, at least ten individual pieces of the mass (or fragments) 10 can be placed within the internal channel 413, and more preferably at least twenty individual pieces of the mass (or fragments) 10 will be placed within the internal channel 413, without limitation.

Next, the test apparatus 400 can be configured to the second (or closed) operational state for inhibiting access to the internal channel 413 by closing the opening and creating a sealed chamber. The pressure control port 414B can be set to increase the pressure within the pressure vessel 410 by allowing fluid from the fluid pressure source 430 to enter the pressure vessel 410. The pressure source 430 may be a gas and/or liquid. A metering valve system 440, for example, can be used to control a rate at which fluid flow from the fluid pressure source 430 into the pressure vessel 410 via valve piping 450. Preferably, the rate of fluid flow can be set such that the pressure within the pressure vessel 410 increases at a rate between fifty kilopascals (kPa) and one thousand kilopascals per minute, more preferably between fifty kilopascals and five hundred kilopascals per minute, and most preferably between fifty kilopascals and three hundred kilopascals per minute, without limitation.

Prior to an increase in pressure within the pressure vessel 410, the mass (or fragments) 10 can float near a top of the water contained within the internal channel 413. As the pressure is increased, gas pockets 14 (shown in FIGS. 1A-C) within the mass (or fragments) 10 can compress and/or break such that the density of the mass (or fragments) 10 increases. As the pressure continues to increase, some of the mass (or fragments) 10 can begin to sink to the bottom of the internal channel 413. As the pressure can be increased further, more of the individual pieces of the mass (or fragments) 10 can sink. The pressure at which between ninety percent and ninety-five percent of the individual pieces of the mass (or fragments) 10 sink to the bottom of the internal channel 413 can be defined as being a critical submersion pressure Pm. Once the critical submersion pressure Pm has been determined, the critical submersion depth Dm can be calculated via Equation 1.

As an Example 1, a test apparatus 400 as shown in FIG. 5 was used to determine the critical submersion pressure, Pm, and the critical submersion depth, dm of wood chips. The wood chips had an oblong shape, with a large dimension ranging between three and four centimeters, a second dimension ranging between two centimeters and three centimeters, and a third dimension ranging between one centimeter and two centimeters. The test apparatus 400 was comprised of a cylindrical tube internal channel 413 made from transparent material, approximately eight centimeters in diameter and sixty centimeters in height, with a pressure rating of fifteen hundred kilopascal. The test apparatus 400 was configured to the first (or open) operational state for permitting access to the internal channel 413 via the opening 413A. Wood chips were loaded into the internal channel 413 and totaled forty individual fragments, filling about nine centimeters of the internal channel 413, about fifteen percent. To ensure that pockets of air from incomplete filling do not interfere with some wood chips, a screen was inserted down the internal channel 413 approximately ten centimeters below the top of the internal channel 413. Water from a lake was then filled into the internal channel 413, such that the water completely filled the internal channel 413 and the test apparatus 400 was then configured to the second (or closed) operational state by closing the opening and creating a sealed chamber. A water pump was used as the fluid pressure source 430 and metered into the pressure vessel 410 so that the pressure increased at a rate of about fifty kilopascals each minute. Individual fragments began to sink at three hundred and fifty kilopascals, and thirty-six pieces had sunk to the bottom when the pressure gauge indicated a pressure of four hundred and fifty kilopascals, giving a critical submersion pressure Pm of 450,000 Pascals.

Equation 4 was used to determine the critical submersion depth, dm, to be forty-five meters, calculated as follows:

$$Example 1 = 450 , 000 / 10 , 000 = 45 meters \qquad ( Equation 5 )$$

### Method 2: Reduced Atmosphere Intrusion

When testing to determine the submersion characteristics of a material by first exposing the mass (or fragments) 10 to a reduced pressure followed by intrusion of liquid, an iterative process can be preferred to determine an approximate value of the required level of reduced pressure. Unlike the previously described method of Application of Positive Pressure where pressure can be delivered continuously throughout the test, the Reduced Atmosphere Intrusion process can be an iterative process, wherein pressure is cycled between a reduced pressure (increasing in intensity each cycle) and atmospheric or above-atmospheric pressure, while the mass (or fragments) 10 remain fully submerged in liquid.

The Reduced Atmosphere Intrusion method begins by configuring the submersion characteristics test apparatus 400 to the first (or open) operational state for permitting access to the internal channel 413 via the opening 413A. Next, mass (or fragments) 10 are loaded into the internal channel 413 via the opening 413A and filled to between ten percent and twenty percent of the height of the internal channel 413, and then water, preferably from the body of water 20, can be used to fill the internal channel 413 to between seventy percent and eighty percent of full capacity of the internal channel 413.

In the manner set forth in more detail above, it is preferred that the mass (or fragments) 10 are able to move around freely within the test chamber, and do not bind up in a manner that prevents movement. Preferably, at least ten individual pieces of the mass (or fragments) 10 will be placed within the internal channel 413, and more preferably at least twenty individual pieces of the mass (or fragments) 10 will be placed within the internal channel 413, without limitation. A tightly fitted screen can be inserted within the internal channel 413 and placed at a location that can be between five centimeters and twenty centimeters below the level of water. The screen can be sized such that the mass (or fragments) 10 do not cross the screen. This forces the mass (or fragments) 10 to remain fully submerged below the surface of the water.

Next, the test apparatus 400 can be configured to the second (or closed) operational state by closing the opening and creating a sealed chamber. The pressure control port 414B can be set to decrease the pressure within the pressure vessel 410 by allowing gas from the pressure vessel 410 to flow towards the pressure source 430, which can be operated below atmospheric pressure. The pressure source 430 may be comprised of a vacuum pump, evacuated tank, blower, or other device used to reduce pressure. Preferably, a device is used that is capable of reducing pressure to at least seven hundred and twenty millimeters of mercury (mmHg), more preferably at least seven hundred and forty millimeters of mercury, and most preferably at least seven hundred and fifty millimeters of mercury, without limitation. Preferably, a vacuum pump trap, condensation trap, or other device can be used as part of the pressure source 430 to prevent water and/or moisture from entering and harming the equipment. A trap can be installed before the intake line of the vacuum pump or other device and may use cold surfaces to force water to condense out of the gas stream and prevent the water from entering the pressure source 430.

The pressure control port 414B can be set to decrease the pressure within the pressure vessel 410 to a first predetermined level and held for at least ten seconds. In one embodiment, the first predetermined level can be between six hundred millimeters of mercury and six hundred and fifty millimeters of mercury. After the hold, atmospheric air can be delivered to the pressure vessel and held at atmospheric pressure for at least ten seconds, completing the first cycle. If ninety percent or more of the mass (or fragments) 10 have sunk to the bottom of the internal channel 413, the test is complete; otherwise, another cycle can be performed. The next cycle can be identical to the first cycle, except the level of vacuum is increased.

A second cycle can begin by setting the pressure control port 414B to decrease the pressure within the pressure vessel 410 to a second predetermined level and held for at least 10 seconds, followed by a return to atmospheric pressure using atmospheric air. In one embodiment, the second predetermined level can be between four hundred and fifty millimeters of mercury and five hundred millimeters of mercury. If ninety percent or more of the mass (or fragments) 10 have sunk to the bottom of the internal channel 413, the test is complete;

otherwise, another cycle can be performed. The cycles are repeated until at least ninety percent of the mass (or fragments) 10 sink to the bottom of the internal channel 413. The level of vacuum applied during each cycle will increase until (1) the test is completed successfully or (2) the applied level of vacuum reaches the maximum capacity of the equipment, in which case the process may not be suitable for the material under test.

Once the test has been completed successfully, the last applied vacuum can be defined as the critical level of vacuum Vc. Large quantities of mass (or fragments) 10 can be exposed to the critical level of vacuum Vc, followed by atmospheric pressure while being submerged, and then dumped at or near the surface of the body of water.

In selected embodiments, there is no fixed requirement for the increase in the level of vacuum applied during each cycle. Smaller increases will result in a result with a higher resolution/accuracy, but smaller increases also require more cycles and therefore a longer testing time. As a user increases experience with materials used for submersion, the user can be able to formulate an estimate and can center the levels of vacuum around their estimate.

In an alternate embodiment, each cycle can use a pressure greater than atmospheric air after application of vacuum. Using a pressure greater than that of atmosphere, may provide additional mechanism(s) to alter the internal structure of the mass (or fragments) 10 and increase the density to a larger amount that with application of atmospheric pressure.

As Example 2, a test apparatus 400 as shown in FIG. 5 was used to determine the critical level of vacuum Vc of wood chips. The wood chips had an oblong shape with a large dimension ranging between three centimeters and four centimeters, a second dimension ranging between two centimeters and three centimeters, and a third dimension ranging between one centimeter and two centimeters. The test apparatus 400 was comprised of a cylindrical tube internal channel 413 made from transparent material, approximately eight centimeters in diameter and sixty centimeters in height, with a pressure rating of 1,500 kPa. The test apparatus 400 was configured to the first (or open) operational state for permitting access to the internal channel 413 via the opening 413A.

Wood chips were loaded into the internal channel 413 and totaled forty individual fragments, filling about nine centimeters of the internal channel 413, about fifteen percent. To ensure that all of the wood chips remain fully submerged below the water line during the test, a screen was inserted down the internal channel 413 approximately ten centimeters below the top of the internal channel 413. Water from a lake was then filled into the internal channel 413, such that the water level was fifty centimeters above the bottom of the internal channel 413 and then configured to the second (or closed) operational state. A vacuum pump was used as the fluid pressure source 430 and drew gas out of the pressure vessel 410 so that the pressure decreased to a predetermined value.

Several cycles were performed, using steps of about fifty millimeters of mercury. The first cycle was set to a level of vacuum of about seven hundred millimeters of mercury, the second was six hundred and fifty millimeters of mercury, and so on, reducing the pressure by fifty millimeters of mercury each cycle. Individual fragments 10 began to sink at four hundred millimeters of mercury, and thirty-six pieces had sunk to the bottom after the cycle with a vacuum of two hundred and fifty millimeters of mercury, giving a critical level of vacuum Vc of two hundred and fifty millimeters of mercury. After the test was complete, larger vessels were filled with mass (or fragments) 10 and exposed to a vacuum level of 250 mm of mercury or higher levels of vacuum, and then exposed to atmospheric pressure while the mass (or fragments) 10 are fully submerged. Mass (or fragments) 10 treated in this manner can be dumped at or near the surface of the body of water and they will fall to the bottom of the body of water.

A description of an alternative embodiment of Method 2, Reduced Atmosphere Intrusion, as used to determine the level of negative pressure required to increase the density of the processed fragments 32 to be greater than the highest density of the water in the body of water 20 (shown in FIGS. 1A-C), is as follows. In one embodiment, the mass (or fragments) 10 can be replaced with new mass (or fragments) 10 after each cycle with the goal of more accurately representing the intended operational characteristics because the mass (or fragments) 10 are not subjected to prior treatment of reduced pressure that may alter aspects of their physical form. In an alternative embodiment, the mass (or fragments) 10 are not replaced with new mass (or fragments) 10 after each cycle. In a yet another alternative embodiment, the mass (or fragments) 10 can be replaced with new mass (or fragments) 10 after every other cycle.

In selected embodiments, the feedstock 30 can be disposed into the internal channel 413 of the pressure vessel 410 during an initial iteration of the test. The feedstock 30, for example, can preferably occupy between five percent and twenty-five percent of the internal channel 413 and more preferably between five and fifteen percent. Water 29, preferably water from the body of water 20, can be added to the feedstock 30 within the internal channel 413. In selected embodiments, the water 29 and feedstock 30 can preferably occupy between fifty percent and one hundred percent of the internal channel 413, and more preferably between sixty percent and eighty percent of the internal channel 413.

The water 29 and/or the feedstock 30 can be inhibited from entering the access ports 414. As illustrated in FIG. 5, the water 29 and/or the feedstock 30 preferably is disposed between the access ports 414 and the second end region 412B of the pressure vessel 410. Stated somewhat differently, the surface level 28 of the water 29 and/or the feedstock 30 can be below the pressure sensing port 414A and/or the pressure control port 414B. In selected embodiments, a mesh screen (not shown) can be introduced into the internal channel 413 of the pressure vessel 410. The opening 413A defined by the first end region 412A, for example, can be disposed in the first (or open) operational state, and the mesh screen can be introduced into the internal channel 413 via the opening 413A. The mesh screen can be positioned within the internal channel 413 to hold the feedstock 30 below the surface of the water 29 within the pressure vessel 410. The first end region 412A then can be disposed in the second (or closed) operational state to seal the pressure vessel 410.

An internal pressure of the pressure vessel 410 can be measured and otherwise monitored via the pressure sensing port 414A. A vacuum pump system or other source of negative pressure (not shown) can be coupled with the pressure control port 414B. The source of negative pressure can generate a negative pressure that can be applied to the internal channel 413 of the pressure vessel 410 via the pressure control port 414B. In selected embodiments, the source of negative pressure can reduce the pressure inside the internal channel 413 at a predetermined rate and/or reach a predetermined level of vacuum. Exemplary predetermined rates can include, but are not limited to, between five hundred Pascal and two thousand Pascal during each time interval of between five seconds and thirty seconds or so.

When the pressure inside the internal channel 413 reaches an initial preselected negative pressure level, such as between four thousand Pascal and six thousand Pascal below atmospheric pressure, the source of negative pressure can be isolated or otherwise disengaged. Atmospheric air can be allowed to flow into the pressure control port 414B until the pressure inside the internal channel 413 equalizes with the atmosphere. In an alternate embodiment, a pressure greater than atmospheric air after application of vacuum. Preferably, the pressure applied after each application of vacuum can be between atmospheric and two thousand kilopascals, and more preferably between atmospheric and one thousand kilopascals, and most preferably the pressure applied after each application of vacuum can be between atmospheric and five hundred kilopascals

A position of the processed fragments 32 within the pressure vessel 410 can be determined once the initial iteration of the test is complete. If the elongated body 411 of the pressure vessel 410 comprises a transparent body, for example, the processed fragments 32 within the pressure vessel 410 can be observed. If the processed fragments 32 sink to the second end region 412B of the pressure vessel 410 after the initial iteration of the test, the level of negative pressure required to increase the density of the processed fragments 32 to be greater than the highest density of the water in the body of water 20 can be between atmospheric pressure and the initial preselected negative pressure level. The above test can be repeated with additional or otherwise different loads of feedstock 30 and application of negative pressures that are less than the pressures applied during the initial iteration of the test during one or more subsequent iterations of the test. An actual negative pressure to be applied to the pressure vessel 410 for the feedstock 30 can be determined with more accuracy with each successive iteration of the test.

If the processed fragments 32 do not sink to the second end region 412B of the pressure vessel 410 (and/or remain primarily at or near the surface level 28 of the water 29 within the pressure vessel 410), the level of negative pressure required to increase the density of the processed fragments 32 to be greater than the highest density of the water in the body of water 20 is greater than the initial preselected negative pressure level applied to the pressure vessel 410 during the initial iteration of the test. The test as set forth above can be repeated with negative pressures that are greater than the initial preselected negative pressure level being successively applied to the pressure vessel 410. In other words, one or more subsequent iterations of the test, can be performed. As described above, the subsequent iterations of the test can be performed after the load of feedstock 30 from the initial iteration can be removed, and a new of load of feedstock 30 can be loaded as described above. In other embodiments, the load of feedstock 30 is not removed and remains in the apparatus for subsequent iterations.

To determine the negative pressure to be applied to the pressure vessel 410 for the feedstock 30 with improved accuracy, fresh feedstock 30 can be used for each iteration. Additionally and/or alternatively, water from the body of water 20 can be used to perform the test and the temperature of which can be controlled using heating and/or refrigeration equipment (not shown) such that the body of water 20 has a density as high as the highest density of water found within the body of water 20.

During a second (or other subsequent) iteration of the test, the pressure within the pressure vessel 410 can be reduced to a second preselected negative pressure level that can be greater than the initial preselected negative pressure level. Exemplary second preselected negative pressure levels can be between ten thousand Pascal below atmospheric pressure and twenty thousand Pascal below atmospheric pressure. When the pressure inside the internal channel 413 reaches the second preselected negative pressure level, the source of negative pressure can be isolated or otherwise disengaged. Atmospheric air can be allowed to flow into the pressure control port 414B until the pressure inside the internal channel 413 equalizes with the atmosphere. After the second iteration of the test in complete, a position of the processed fragments 32 within the pressure vessel 410 can be determined at atmospheric pressure in the manner set forth above with reference to the initial iteration of the test.

If the processed fragments 32 sink to the second end region 412B of the pressure vessel 410 after the second iteration of the test, the level of negative pressure required to increase the density of the processed fragments 32 to be greater than the highest density of the water in the body of water 20 can be between the initial preselected negative pressure level and the second preselected negative pressure level. If more accuracy is desired, the test can be again repeated with the pressure within the pressure vessel 410 being reduced to a third preselected negative pressure level between the first preselected negative pressure level and the second preselected negative pressure level. If the processed fragments 32 have not sunk to the second end region 412B of the pressure vessel 410, the required negative pressure can be greater than the third preselected negative pressure level, and the test can be again repeated.

Atmospheric pressure can vary based on location and/or weather conditions but is generally around one hundred thousand Pascals. A number of test iterations and an initial negative pressure level for each test can help determine an accuracy to which a target negative pressure level required to increase the density of the processed fragments 32 to be greater than the highest density of the water in the body of water 20 can be identified. Testing of various feedstock 30 can lead to a database system (or circuit) of target negative pressure levels that can be used to determine the step size and initial preselected negative pressure levels for testing.

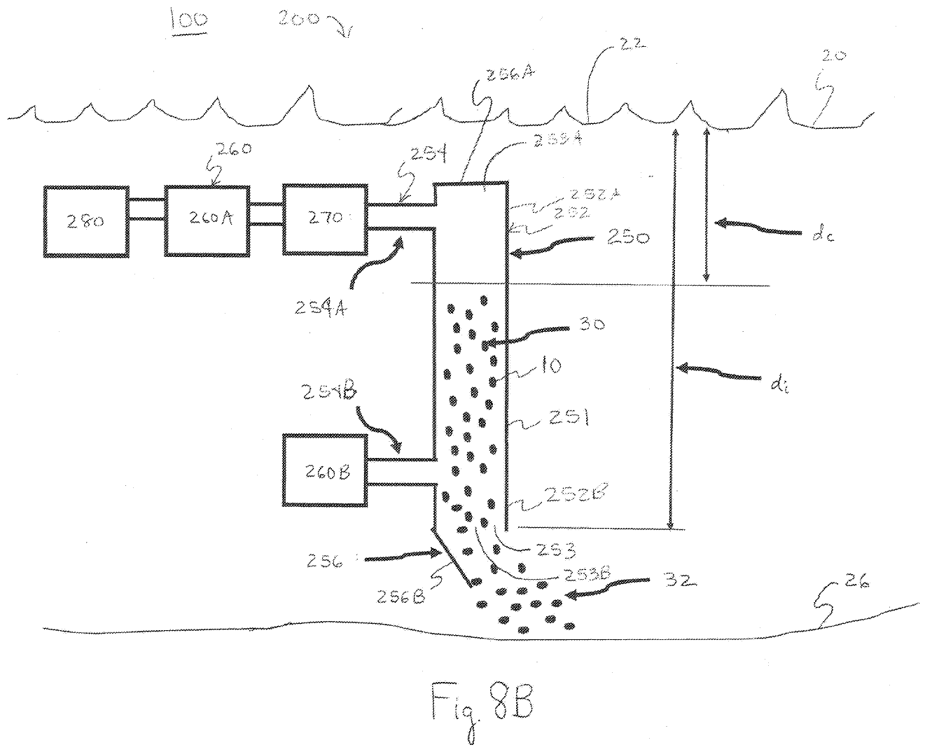

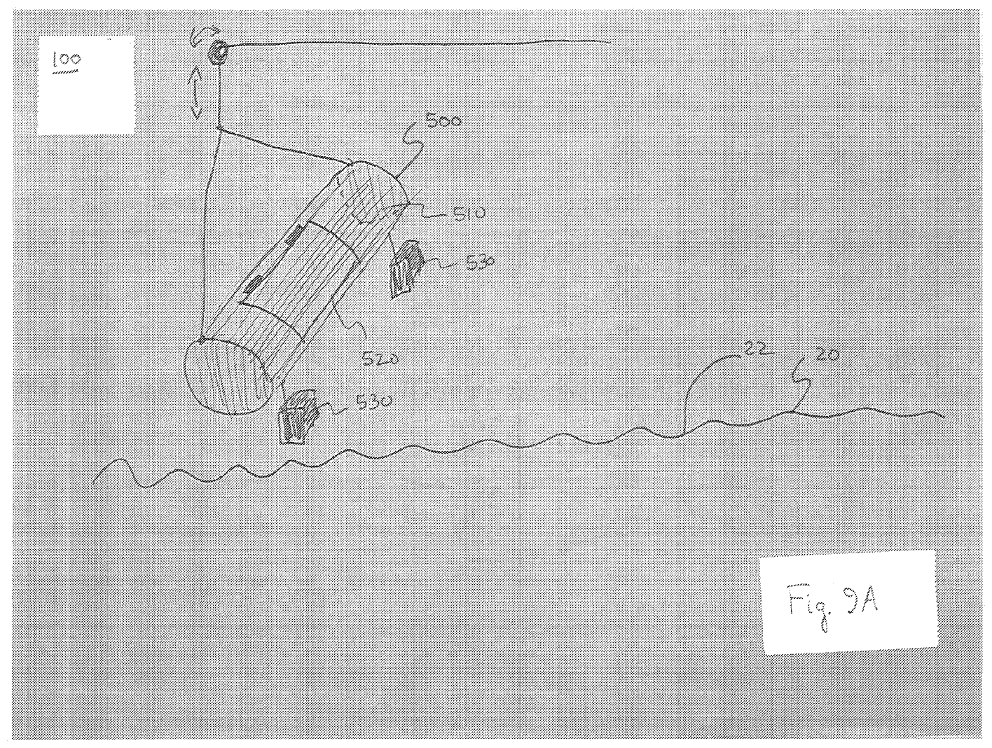

Once the target negative pressure level has been determined to a sufficient accuracy, the submersion vessel 250 of the carbon-containing material submersion system 200 operating in the negative pressure mode can be disposed in the loading position in the manner discussed in more detail above with reference to FIG. 8A.

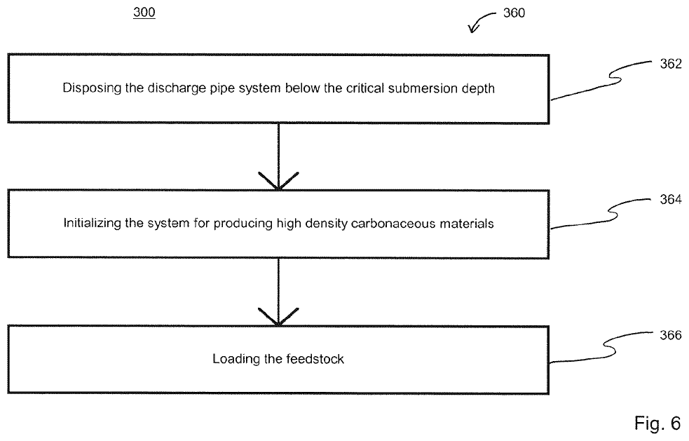

In the manner discussed in more detail above with reference to FIG. 3, the dense processed fragments 32 can be disposed, at 360, at the predetermined injection depth dᵢ (shown in FIGS. 2A-B) below or otherwise relative to the water surface 22 of the body of water 20. The predetermined injection depth dᵢ preferably is greater (or deeper) than the critical submersion depth d_{c}. The dense processed fragments 32 can be disposed, at 360, at the predetermined injection depth dᵢ in any suitable manner. An exemplary manner for disposing the dense processed fragments 32 at a predetermined injection depth dᵢ is illustrated in FIG. 6.

Turning to FIG. 6 in conjunction with FIGS. 2A-B, the discharge pipe system 230 can be disposed, at 362, below the water surface 22 at a depth that is below the critical submersion depth d_{c}. The distal end region 234 of the discharge pipe system 230, in other words, can extend below the water surface 22 to the predetermined injection depth dᵢ below or otherwise relative to the water surface 22, wherein the predetermined injection depth dᵢ is greater than the critical submersion depth d_{c}. The distal end region 234 thereby can provide an injection point for introducing the dense processed fragments 32 into the body of water 20. In selected embodiments, the injection point can be within a predetermined depth range below the critical submersion depth d_{c}. The injection point, for example, can be between at least five and one hundred meters below, and more preferably between at least five and twenty meters below, the critical submersion depth d_{c} such that a majority of the dense processed fragments 32 remain submerged and/or sink to the floor 26 of the body of water 20.

The method 100 can include initializing, at 364, the system 100 for producing the high density carbon-containing materials and depositing the materials at the floor 26 of the body of water 20. The system initialization can be performed in any suitable manner. The system 100, for example, can be initialized, at 364, by supplying water to the pump system 210. Stated somewhat differently, a flow of water can be initiated into the pump system 210, and the pump system 210 (or a pump motor (not shown) of the pump system 210) can be engaged.

Additionally and/or alternatively, the feedstock 30 can be loaded, at 366, into the hopper system 220. The feedstock 30 can be loaded into the hopper system 220 in any suitable manner. For example, a front-end loader system (not shown) can be used to drop feedstock 30 into the hopper system 220 via the hopper loading section 224 and/or a conveyor system (not shown) may be configured to deliver the feedstock 30 into the hopper system 220. The pump system 210 can receive fragments 10 comprising the feedstock 30 from the hopper system 220 and can pump the fragments 10.

In selected embodiments, a vibration system (not shown) can help move the feedstock 30 from the hopper loading section 224 of the hopper system 220 to the hopper system outlet 222 and, in turn, to the pump inlet port 212 of pump system 210. The vibration system can be separate from, or at least partially incorporated with, the hopper system 220. In other words, the vibration system can be incorporated with the hopper system 220 in whole and/or in part. The feedstock 30 can be loaded is loaded into the hopper system 220 to begin the submersion of processed fragments 32.

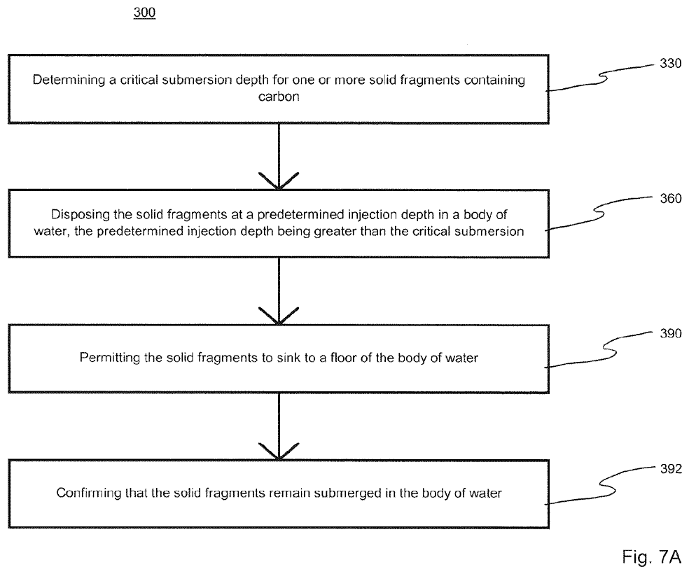

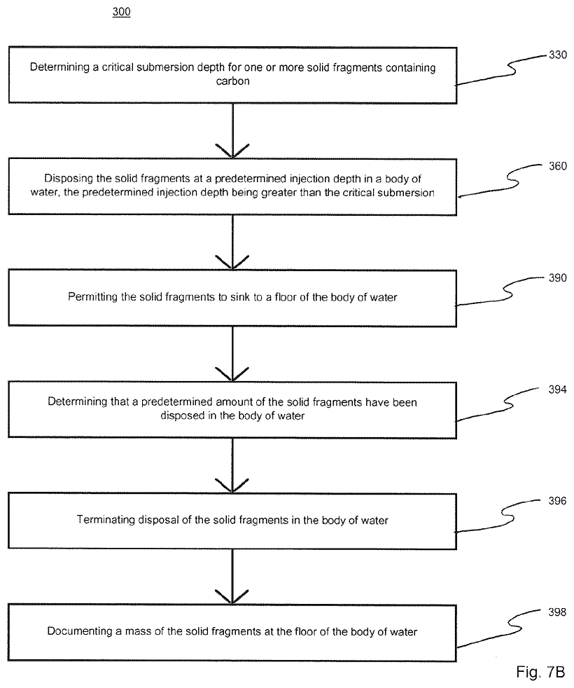

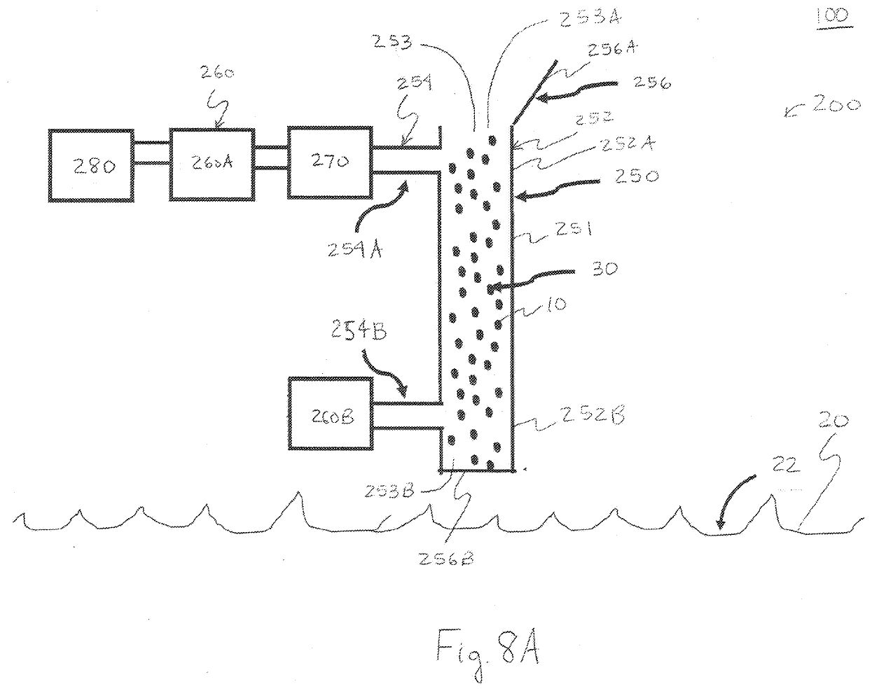

As illustrated in FIG. 7A, the method 100 optionally can include, at 392, confirming that the processed fragments 32 remain submerged in the body of water 20. The submersion of the processed fragments 32 can be confirmed, for example, via manual observation of the processed fragments 32 at the water surface 22 of the body of water 20. The observation can be performed in any suitable manner such as via manual observation by one or more operators or other users (not shown) and/or via optical or other suitable automated observation techniques that can be performed on the water surface 22 of the body of water 20. The observation preferably can be performed at an area on the water surface 22 above the distal end region 234 of the discharge pipe system 230.

An acceptable level of the processed fragments 32 rising to the water surface 22 can be determined. If an amount of the processed fragments 32 observed rising to the water surface 22 is greater than the acceptable level, the distal end region 234 of the discharge pipe system 230 can be lowered further into the body of water 20 in an effort to reduce the amount of the processed fragments 32 rising to the water surface 22. In other words, the predetermined injection depth dᵢ below or otherwise relative to the water surface 22 can be increased to reduce the amount of the processed fragments 32 rising to the water surface 22. In selected embodiments, the processed fragments 32 can be collected over a predetermined area, and a mass of the collected processed fragments 32 can be estimated or otherwise determined.

The method 100 can continue to dispose the processed fragments 32 into the body of water 20, at 360, until a determination is made, at 394, that a predetermined amount of the processed fragments 32 has been disposed into the body of water 20 as illustrated in FIG. 7B. Based upon the determination, at 394, the method 100 can be terminated, at 396. The method 100, in other words, can include terminating disposal of the processed fragments 32 in the body of water 20, at 396. In selected embodiments, terminating disposal of the processed fragments 32 in the body of water 20, at 396, can include deactivating the pump system 210 (shown in FIGS. 2A-B) and/or terminating or otherwise suspending the loading of the feedstock 30 into the hopper system 220 (shown in FIGS. 2A-B). At 398, a total amount of mass of the processed fragments 32 submerged into the body of water 20 can be documented. An under-water camera system (or circuit) (not shown), for example, can be used to document the location and other details of the mass of the processed fragments 32 disposed in the body of water 20.

An alternative embodiment of the carbon-containing material submersion system 200 for submerging carbon-containing materials and creating submerged carbon-containing material is illustrated in FIGS. 8A-B. Turning to FIGS. 8A-B, the carbon-containing material submersion system 200 is shown as including a submersion vessel 250. The submersion vessel 250 can comprise an elongated body 251 that includes opposite end regions 252 and that defines an internal channel 253.

A first (or upper) end region 252A of the submersion vessel 250 can define a first opening 253A that can communicate with the internal channel 253 and that can alternate between a first (or open) operational state for permitting access to the internal channel 253 via the first opening 253A and a second (or closed) operational state for inhibiting access to the internal channel 253 via the first opening 253A. In other words, the first end region 252A can comprise an open end region in the first operational state and a closed end region in the second operational state. In selected embodiments, the first end region 252A can be associated with a first adjustable cover system 256A.

The first adjustable cover system 256A can be adjustably coupled with the first end region 252A, for example, via a hinge system (not shown). In the first operational state, the first adjustable cover system 256A can seal the first opening 253A of the first end region 252A; whereas, first adjustable cover system 256A can unseal the first opening 253A of the first end region 252A in the second operation state. The first end region 252A optionally can be manually and/or automatically actuated to transition between the first and second operational states. In selected embodiments, the first end region 252A can be remotely actuated and/or can be actuated to transition between the first and second operational states in a rapid manner.

A second (or lower) end region 252B of the submersion vessel 250 can define a second opening 253B that can communicate with the internal channel 253 and that can alternate between a first (or open) operational state for permitting access to the internal channel 253 via the second opening 253B and a second (or closed) operational state for inhibiting access to the internal channel 253 via the second opening 253B. In other words, the second end region 252B can comprise an open end region in the first operational state and a closed end region in the second operational state. In selected embodiments, the second end region 252B can be associated with a second adjustable cover system 256B. The second adjustable cover system 256B can be adjustably coupled with the second end region 252B, for example, via a hinge system (not shown).

In the first operational state, the second adjustable cover system 256B can seal the second opening 253B of the second end region 252B; whereas, second adjustable cover system 256B can unseal the second opening 253B of the second end region 252B in the second operation state. The second end region 252B optionally can be manually and/or automatically actuated to transition between the first and second operational states. In selected embodiments, the second end region 252B can be remotely actuated and/or can be actuated to transition between the first and second operational states in a rapid manner.

As illustrated in FIGS. 8A-B, the submersion vessel 250 can include one or more access ports 254. At least one of the access ports 254 can be in communication with the internal channel 253 of the submersion vessel 250 and can be directly and/or indirectly coupled with a control valve 260. Each control valve 260 optionally can be manually and/or automatically actuated to transition between open and closed operational states. In selected embodiments, the control valve 260 can be remotely actuated and/or can be actuated to transition between the open and closed operational states in a rapid manner.

Exemplary access ports 254 can include, but are not limited to, a pressure sensing port 254A and/or a water supply port 254B. The pressure sensing port 254A can be mechanically fixed to the submersion vessel 250 and/or can be in communication with the internal channel 253 of the submersion vessel 250. As shown in FIGS. 8A-B, the pressure sensing port 254A can be coupled with a pressure sensor system (or circuit) 270 for determining an internal pressure inside of the submersion vessel 250. Additionally and/or alternatively, the pressure sensing port 254A can be coupled with a first control valve 260A for controlling access to the internal channel 253 of the submersion vessel 250. A fluid pressure source system 280 optionally can be coupled with, and have an internal connection to, the first control valve 260A to allow fluid exchange between the fluid pressure source system 280 and the internal channel 253 of the submersion vessel 250 when the first control valve 260A is the open operational state or in an optional partially-open state.

The water supply port 254B can be mechanically fixed to the submersion vessel 250 and/or can be in communication with the internal channel 253 of the submersion vessel 250. As illustrated in FIGS. 8A-B, the water supply port 254B can be coupled with a second control valve 260B for controlling access to the internal channel 253 of the submersion vessel 250. The second control valve 260B can permit allow fluid exchange between the body of water 20 and the internal channel 253 of the submersion vessel 250 when the submersion vessel 250 is submerged and the second control valve 260B is the open operational state or in an optional partially-open state.

Turning to FIG. 8A, the submersion vessel 250 is shown as being disposed in a loading position. The submersion vessel 250, in the loading position, can be least partially above the water surface 22 of the body of water 20. Stated somewhat differently, the submersion vessel 250 can be partially or entirely above the water surface 22 of the body of water 20 when in the loading position. In selected embodiments, a portion of the submersion vessel 250 in the loading position can be submerged in the body of water 20.

While disposed in the loading position, the submersion vessel 250 can be loaded with the feedstock 30. The first end region 252A of the submersion vessel 250 in the loading position can be positioned in the first operational state such that the feedstock 30 can be disposed within the internal channel 253 via the first opening 253A. The second end region 252B of the submersion vessel 250 likewise can be positioned in the second operational state such that the second end region 252B comprises the closed end region for retaining the loaded feedstock 30 within the internal channel 253 of the submersion vessel 250.

The feedstock 30 can be loaded into the submersion vessel 250 in any suitable manner. For example, front-end loader system (not shown) can be used to drop feedstock 30 through the first opening 253A of the submersion vessel 250 and into the internal channel 253. Water, such as water from the body of water 20, optionally can be delivered into the internal channel 253 of the submersion vessel 250. The water can be delivered into the internal channel 253 while the submersion vessel 250 is disposed in the loading position. Stated somewhat differently, the water can be delivered into the internal channel 253 when the submersion vessel 250 is above the water surface 22 of the body of water 20, when the submersion vessel 250 is partially submerged in the body of water 20 and/or when the submersion vessel 250 is entirely submerged in the body of water 20. The water can be delivered into the internal channel 253 via a water feed pump system (not shown), via a gravity fee and/or via any other suitable manner. In selected embodiments, a ratio of an amount of delivered water to an amount of loaded feedstock 30 can be based upon a mass of the feedstock 30 loaded into the submersion vessel 250.

The carbon-containing material submersion system 200 may be operated in any one of various operation modes. Exemplary operation modes of the carbon-containing material submersion system 200 can include, but are not limited to, a positive pressure mode, a negative pressure mode, and a mixed positive/negative pressure mode.

### Positive Pressure Mode

In selected embodiments, the carbon-containing material submersion system 200 advantageously can be operated in a positive pressure mode. In the positive pressure mode, the carbon-containing material submersion system 200 can determine the critical submersion depth d_{c} (shown in FIG. 8B) in the manner set forth herein. The critical submersion depth d_{c}, for example, can be determined via the submersion characteristics test apparatus 400 shown in FIG. 5.

As illustrated in FIG. 8A, the submersion vessel 250 can be disposed in the loading position. While disposed in the loading position, the submersion vessel 250 can be loaded with the feedstock 30. The first end region 252A of the submersion vessel 250 in the loading position can be positioned in the first operational state such that the feedstock 30 can be disposed within the internal channel 253 via the first opening 253A. The second end region 252B of the submersion vessel 250 likewise can be positioned in the second operational state such that the second end region 252B comprises the closed end region for retaining the loaded feedstock 30 within the internal channel 253 of the submersion vessel 250.

A predetermined amount of the feedstock 30 can be loaded into the submersion vessel 250. Stated somewhat differently, the internal channel 253 of the submersion vessel 250 can be filled to a predetermined level with the feedstock 30. Once the feedstock 30 is loaded into the submersion vessel 250, the first end region 252A of the submersion vessel 250 can transition from the first operational state to the second operational state. In selected embodiments, the first end region 252A of the submersion vessel 250 can be actuated, such as remotely actuated, to transition from the first operational state to the second operational state. The first end region 252A thereby can transition into the closed end region in the second operational state, and the loaded feedstock 30 can be retained within the internal channel 253 of the submersion vessel 250.

The submersion vessel 250 with the loaded feedstock 30 can be submerged into the body of water 20 as shown in FIG. 8B. In selected embodiments, the submersion vessel 250 with the loaded feedstock 30 can be fully submerged into the body of water 20. Water from the body of water 20 can be supplied to the internal channel 253 of the submerged submersion vessel 250 via the water supply port 254B. For example, the second control valve 260B can be actuated, such as remotely actuated, to transition from the closed operational state to the open operational state to permit the water to enter the water supply port 254B and flow into the internal channel 253.

The first control valve 260A of the submerged submersion vessel 250 optionally can be actuated, such as remotely actuated, to transition from the closed operational state to the open operational state to permit venting of any air and/or other gasses within the internal channel 253 that are displaced by the water supplied to the internal channel 253. The displaced air and/or other gasses, for example, can be vented to the atmosphere adjacent to the submersion vessel 250.

Additionally and/or alternatively, the first control valve 260A can be actuated, such as remotely actuated, to transition from the closed operational state to the open operational state upon submersion of the submersion vessel 250 into the body of water 20. Any air and/or other gasses within the internal channel 253 of the submersion vessel 250 thereby can escape to the atmosphere while water is supplied to the internal channel 253 of the submersion vessel 250 through the water supply port 254B. In selected embodiments, a screen (not shown) smaller than the fragments 10 of the feedstock 30 can be placed within the submersion vessel 250 covering the pressure sensing port 254A to prevent the feedstock 30 from entering and possibly clogging, the pressure sensing port 254A.

The second control valve 260B can permit a predetermined amount of water to flow into the internal channel 253 of the submersion vessel 250. The supply of water can be terminated, and the predetermined amount of water can be retained within the internal channel 253. In selected embodiments, the second control valve 260B can maintain the open operational state after the supply of water is terminated.

The submersion vessel 250 with the loaded feedstock 30 and the predetermined amount of water can be submerged into the body of water 20 to a depth that is greater than the critical submersion depth d_{c} below or otherwise relative to the water surface 22. In other words, at least a portion of the submersion vessel 250 can be submerged to the depth that is greater than the critical submersion depth d_{c}. As shown in FIG. 8B, for example, the second end region 252B of the submersion vessel 250 can be submerged to the predetermined injection depth dᵢ below or otherwise relative to the water surface 22 that is greater (or deeper) than the critical submersion depth d_{c}. Pressure within the submerged submersion vessel 250 advantageously can equalize with the pressure of the water surrounding the submersion vessel 250 because the second control valve 260B continues to maintain the open operational state. Fluid exchange between the body of water 20 and the internal channel 253 of the submersion vessel 250 thereby can be allowed through the open water supply port 254B.

In selected embodiments, a predetermined amount of time can be allowed to elapse after the submersion vessel 250 reaches the desired depth to allow the feedstock 30 to equalize and be treated to form the processed fragments 32. Once the predetermined amount of time has elapsed, the second end region 252B of the submersion vessel 250 can transition from the second operational state to the first operational state. In the first operational state, the second end region 252B can comprise an open end region. In selected embodiments, the second end region 252B of the submersion vessel 250 can be actuated, such as remotely actuated, to transition from the second operational state to the first operational state. The submerged submersion vessel 250 thereby can be disposed into an unloading position.

With the second end region 252B in the first operational state, the processed fragments 32 can exit the submersion vessel 250 and sink to the floor 26 of the body of water 20. The processed fragments 32 can remain on the floor 26 of the body of water 20 indefinitely. The processed fragments 32 may be pushed along the floor 26 of the body of water 20 by water currents where the processed fragments 32 should continue to settle into deeper and deeper water as the processed fragments 32 moves along slopes of the floor 26. Although shown and described with reference to FIG. 8B as being fully submerged for purposes of illustration only, the submersion vessel 250 can be partially submerged below the water surface 22 of the body of water 20 as long as the second end region 252B is submerged to the predetermined injection depth dᵢ that is greater (or deeper) than the critical submersion depth d_{c}.

In an alternative embodiment, the vessel can be contrasted of wire mesh, or other material that allows communication of the water between outside and inside of the vessel. As Example 3, carbon-containing material submersion system 200 was used to increase

the density of a several tons of wood chips. The carbon-containing material submersion system 200 was operated on shore near the edge of the body of water 20 in which the feedstock 30 comprised of fragments 10 will be submerged. The starting material included sections of limbs of trees ranging from twenty centimeters to two centimeters in diameter up to five meters in length. The limbs were reduced in size to fragments 10 with a volume of three cubic centimeters or smaller, by using a common wood chipper. The density of the fragments 10 after chipping was approximately eight-tenths of a gram per cubic centimeter.

While disposed in the loading position, the feedstock 30 was loaded into the internal channel 253, as described with regard to FIG. 8 above, and filled to within ten centimeters of the top of the internal channel 253. Water from the body of water 20 was pumped into the internal channel 253, using a water pump and piping, and filled to maximum capacity (until overflow of water was observed). After loading the feedstock 30 and water into the submersion vessel 250, the first end region 252A of the submersion vessel 250 was transitioned from the first operational state to the second operational state (closed).

The fluid pressure source system 280, comprised of a water pump capable of pumping to pressures greater than two thousand kilopascals, was used to generate a positive pressure (pressure greater than atmospheric pressure) that was applied to the internal channel 253 of the submersion vessel 250 via the pressure sensing port 254A. The internal pressure of the submersion vessel 250 was monitored via the pressure sensing port 254A using a pressure gauge. The fluid pressure source system 280 was used to increase the pressure inside the internal channel 253 to one thousand kilopascals. Next, the first control valve 260A, comprised of a standard two-way manually actuated ball valve, of the submerged submersion vessel 250 was actuated to permit atmospheric air to enter the internal channel 253 residing at reduced pressure until the pressure within the internal channel 253 equalized with atmospheric pressure. A total of five cycles were applied to the feedstock 30 (each cycle comprising application of positive pressure followed by a return to atmospheric pressure).

After application of the fifth cycle and return to atmospheric pressure, the carbon-containing material submersion system 200 was configured in the first (open) position allowing removal of the feedstock 30. The feedstock was removed from the internal channel 253 and set aside allowing the fragments 10 and placed on a screen allowing any free water to drain. It was determined that the density of the fragments 10 were increased from the starting density of approximately eight-tenths of a gram per cubic centimeter to a density of approximately 1.03 grams per cubic centimeter. The feedstock 30 comprising the fragments 10 were then loaded onto a split hopper barge, where they were then sailed to a predetermined location in the body of water 20. The split hopper barge was then opened (split to allow loaded material to drop) and the feedstock 30 was dropped into the body of water 20, where they sunk to the bottom of the body of water 20.

### Negative Pressure Mode

In selected embodiments, the carbon-containing material submersion system 200 advantageously can be operated in a negative pressure mode. In the negative pressure mode, the feedstock 30 within the submersion vessel 250 can be subjected to a negative pressure (or a vacuum) that is less than atmospheric pressure. The negative pressure can cause the air and/or one or more other gasses within the gas pockets or cavities 14 (shown in FIGS. 1A-C) of the fragments 10 within the feedstock 30 to be drawn out of the gas pockets 14. The air and/or other gasses can be partially or fully drawn out and exit the gas pockets 14 depending on a level of the negative pressure applied to the feedstock 30.

If the feedstock 30 is subjected to the negative pressure while surrounded by water 29, the air and/or other gasses can be inhibited from re-entering the gas pockets 14 within the fragments 10 and other feedstock 30. In other words, the drawn-out air and/or other gasses can be replaced by the water 29, such as water from the body of water 20 (shown in FIGS. 1A-C), surrounding the fragments 10 when the feedstock 30 is subjected to the negative pressure. By replacing the air and/or other gasses with the water 29, a density of the fragments 10 can increase.

As a unique feature of the carbon-containing material submersion system 200 in the negative pressure mode, the increase in the density of the fragments 10 while being processed into the processed fragments 32 can be fully irreversible or partially irreversible. The density of the processed fragments 32 can remain increased, for example, as long as the processed fragments 32 are not exposed to air and/or other gasses after the application of the negative pressure. With some materials for submersion and embodiments, the density of the processed fragments 32 can remain increased permanently, or for long periods of time (greater than several hours), even in the cases where the processed fragments 32 are exposed to air and/or other gasses after the application of the negative pressure. This is due to the voids and gas pockets being displaced by water and having no mechanism to discharge the water and replace the lost gases.

In selected embodiments, the carbon-containing material submersion system 200 in the negative pressure mode can be used to determine the level of negative pressure required to increase the density of the processed fragments 32 to be greater than a highest density of the water in the body of water 20. If the density of the processed fragments 32 can be increased to a level that is greater than the highest density of the water in the body of water 20, the processed fragments 32 advantageously can be discharged at or near the water surface 22 of the body of water 20. The processed fragments 32 with the increased density then can be permitted to sink to the floor 26 of the body of water 20. Discharging near the water surface 22 can be a significant operational advantage and may provide for the most efficient and cost-effective operation. The method used to operate the system is similar to that described herein for the submersion characteristics test apparatus 400.

Returning to FIG. 8A, the submersion vessel 250, while disposed in the loading position, can be loaded with the feedstock 30. The first end region 252A of the submersion vessel 250 in the loading position can be positioned in the first operational state such that the feedstock 30 can be disposed within the internal channel 253 via the first opening 253A; whereas, the second end region 252B of the submersion vessel 250 can be positioned in the second operational state such that the second end region 252B comprises the closed end region for retaining the loaded feedstock 30 within the internal channel 253 of the submersion vessel 250. The predetermined amount of the feedstock 30 can be loaded into the submersion vessel 250 in the manner set forth in more detail above with reference to FIG. 8A. Once the feedstock 30 is loaded into the submersion vessel 250, the first end region 252A of the submersion vessel 250 can transition from the first operational state to the second operational state.

The submersion vessel 250 with the loaded feedstock 30 can be submerged into the body of water 20 as shown in FIG. 8B. In selected embodiments, the submersion vessel 250 with the loaded feedstock 30 can be partially or fully submerged into the body of water 20. At least the second end region 252B of the submersion vessel 250 preferably is disposed below the water surface 22 of the body of water 20. If gravity feed is going to be used for filling the internal channel 253 of the submersion vessel 250 with water, the submersion vessel 250 can be submerged to at least a depth below or otherwise relative to the water surface 22 at which the water level is desired.

In selected embodiments, the submersion vessel 250 with the loaded feedstock 30 can be fully submerged into the body of water 20. Water from the body of water 20 can be supplied to the internal channel 253 of the submerged submersion vessel 250 via the water supply port 254B. For example, the second control valve 260B can be actuated to transition from the closed operational state to the open operational state to permit the water to enter the water supply port 254B and flow into the internal channel 253 in the manner discussed in more detail above.

The first control valve 260A of the submerged submersion vessel 250 optionally can be actuated to transition from the closed operational state to the open operational state to permit venting of any air and/or other gasses within the internal channel 253 that are displaced by the water supplied to the internal channel 253. The displaced air and/or other gasses, for example, can be vented to the atmosphere adjacent to the submersion vessel 250. In selected embodiments, the first control valve 260A can comprise a one-way valve that can permit air and/or other gasses to escape from the internal channel 253 while preventing water from flowing into the internal channel 253. Preferably, a water level inside the internal channel 253 can be established and/or maintained below the pressure sensing port 254A to help avoid water being drawn into the internal channel 253 as the negative pressure is applied.

An internal pressure of the submersion vessel 250 can be measured and otherwise monitored via the pressure sensing port 254A. As shown in FIG. 8B, the fluid pressure source system 280 likewise can be coupled with the pressure sensing port 254A. The fluid pressure source system 280 can generate a negative pressure that is applied to the internal channel 253 of the submersion vessel 250 via the pressure sensing port 254A. In selected embodiments, the fluid pressure source system 280 can reduce the pressure inside the internal channel 253 at a predetermined rate. Exemplary predetermined rates can include, but are not limited to, between five hundred Pascal and two thousand Pascal during each time interval of between five seconds and thirty seconds or so.

The fluid pressure source system 280, for example, can reduce the pressure inside the internal channel 253 to the target negative pressure level as determined by the submersion characteristics test apparatus 400 in the manner discussed in more detail above with reference to FIG. 5. When the pressure inside the internal channel 253 reaches the target negative pressure level, the density of the fragments 10 within the feedstock 30 can increase to form the processed fragments 32 with an increased density that is than the highest density of the water in the body of water 20. The second end region 252B can be actuated, such as remotely actuated, to transition from the second (or closed) operational state to the first (or open) operational state. With the second end region 252B in the first operational state, the processed fragments 32 can exit the submersion vessel 250 and sink to the floor 26 of the body of water 20. The processed fragments 32 can remain on the floor 26 of the body of water 20 indefinitely. The processed fragments 32 may be pushed along the floor 26 of the body of water 20 by water currents where the processed fragments 32 should continue to settle into deeper and deeper water as the processed fragments 32 moves along slopes of the floor 26.

Mixed Positive and/or Negative Pressure Mode

In selected embodiments, the carbon-containing material submersion system 200 can be operated in a mixed positive and/or negative pressure mode. In the mixed positive and/or negative pressure mode, a negative pressure as described above in the Negative Pressure Mode can be applied to reduce the critical submersion depth d_{c} of the positive pressure mode. As the negative pressure mode is applied, the gas pockets or cavities 14 within feedstock fragments 10 can be drawn out and replaced with water as the applied negative pressure returns to equilibrium with the atmosphere (or to a predetermined pressure above atmospheric pressure), while the fragments 10 are submerged. Processing the fragments 10 to replace the gas pockets 14 with water can help increase the density of the processed fragments 32 and/or lower the pressure required to sink the processed fragments 32 with the increased density. In some embodiments, the fragments 10 may be exposed to more than one cycle of reduced atmospheric pressure followed by atmospheric or greater pressure, as described above.

As Example 4, carbon-containing material submersion system 200 was used to increase the density of a several tons of wood chips. The carbon-containing material submersion system 200 was operated on shore near the edge of the body of water 20 in which the feedstock 30 comprised of fragments 10 will be submerged. The starting material was sections of limbs of trees ranging from twenty centimeters to two centimeters in diameter up to five meters in length. The limbs were reduced in size to fragments 10 with a volume of five cubic centimeters or smaller, by using a common wood chipper. The density of the fragments 10 after chipping was approximately seven-tenths of a gram per cubic centimeter.

While disposed in the loading position, feedstock 30 was loaded into the internal channel 253, as described with regard to FIG. 8 above, and filled to within ten centimeters of the top of the internal channel 253. Water from the body of water 20 was pumped into the internal channel 253, using a water pump and piping, and filled to maximum capacity (until overflow of water was observed). After loading the feedstock 30 and water into the submersion vessel 250, the first end region 252A of the submersion vessel 250 was transitioned from the first operational state to the second operational state (closed).

The fluid pressure source system 280 comprised of a vacuum pump was used to generate a negative pressure that was applied to the internal channel 253 of the submersion vessel 250 via the pressure sensing port 254A. The internal pressure of the submersion vessel 250 was monitored via the pressure sensing port 254A using a pressure gauge. The fluid pressure source system 280 was used to reduce the pressure inside the internal channel 253 to one hundred millimeters of mercury. Next, the first control valve 260A, comprised of a standard two-way manually actuated ball valve, of the submerged submersion vessel 250 was actuated to permit atmospheric air to enter the internal channel 253 residing at reduced pressure until the pressure within the internal channel 253 equalized with atmospheric pressure. A pressure source, comprised of an air compressor, was configured using piping to flow into the first control valve 260A to increase the quantity of air within the internal channel 253 thereby increasing the pressure within the internal channel 253 above atmospheric pressure to a pressure of four hundred kilopascals. The pressure within the internal channel 253 was then returned by atmospheric pressure by opening the first control valve 260A, while the first control valve 260A is configured to allow a piped flow between the internal channel 253 to atmosphere. A total of three cycles were applied to the feedstock 30 (each cycle comprising application of vacuum followed by a return to atmospheric pressure, followed by application of positive pressure, and then return to atmospheric pressure).

After application of the third cycle and returned to atmospheric pressure, the carbon-containing material submersion system 200 was configured in the first (open) position allowing removal of the feedstock 30. The feedstock was removed from the internal channel 253 and set aside allowing any residual water to drain. It was determined that the density of the fragments 10 were increased from the starting density of approximately 0.7 grams per cubic centimeter to a density of approximately 1.05 grams per cubic centimeter. The feedstock 30 comprising the fragments 10 were then loaded onto a split hopper barge, where they were combined with other treated materials and sailed to a predetermined location in the body of water 20. The split hopper barge was then opened (split to allow loaded material to drop) and the feedstock 30 was dropped into the body of water 20, where they sunk to the bottom of the body of water 20.

The embodiments disclosed herein are not limited to the examples described above and may be used in any combination with each other. Several of the embodiments may be combined together to form a further embodiment. A method or a system, disclosed herein, may comprise at least one of the embodiments described hereinbefore. It will be understood that the benefits and advantages described above may relate to selected embodiments or may relate to several embodiments. The embodiments are not limited to those that solve any or all of the stated problems or those that have any or all of the stated benefits and advantages. It will further be understood that reference to ‘an’ item refers to one or more of that item. The term “comprising” is used in this specification to mean including the feature(s) or act(s) followed thereafter, without excluding the presence of one or more additional features or acts.

In selected embodiments, one or more of the features disclosed herein can be provided as a computer program product. The computer program product, for example, can be encoded on one or more non-transitory machine-readable storage media, such as magnetic, optical and/or electronic storage media of any kind and without limitation. As used herein, a phrase in the form of at least one of A, B, C and D herein is to be construed as meaning one or more of A, one or more of B, one or more of C and/or one or more of D. Likewise, a phrase in the form of A, B, C or D as used herein is to be construed as meaning A or B or C or D. For example, a phrase in the form of A, B, C or a combination thereof is to be construed as meaning A or B or C or any combination of A, B and/or C.

The disclosed embodiments are susceptible to various modifications and alternative forms, and specific examples thereof have been shown by way of example in the drawings and are herein described in detail. It should be understood, however, that the disclosed embodiments are not to be limited to the particular forms or methods disclosed, but to the contrary, the disclosed embodiments are to cover all modifications, equivalents, and alternatives.

1-66. (canceled)

67. A method for creating submerged carbon-containing material, comprising:
applying an applied pressure that is different from an atmospheric pressure to a feedstock containing carbon; and
sequestering the pressurized feedstock in a body of water.

68. The method of claim 67, wherein said applying the applied pressure comprises applying the applied pressure that is:
(a) greater than the atmospheric pressure to the feedstock; or
(b) less than the atmospheric pressure to the feedstock,
optionally, wherein said applying the applied pressure comprises applying a vacuum to the feedstock.

69. The method of claim 67, wherein said sequestering the pressurized feedstock comprises:
a) sequestering the pressurized feedstock in a body of fresh water or in a body of salt water; and/or
b) sinking the pressurized feedstock in the body of water.

70. The method of claim 67, wherein the feedstock comprises:
a) a biomass; and/or
b) one or more fragments containing carbon.

71. The method of claim 67, wherein the feedstock comprises at least one low-density structure that is capable of being compressed; optionally wherein:
a) the feedstock defines one or more gas pockets; optionally wherein at least one of the gas pockets contains air; and/or
b) said applying the applied pressure comprises applying the applied pressure for compressing the at least one low-density structure of the feedstock; and/or
c) said applying the applied pressure comprises applying the applied pressure for increasing a feedstock density of the feedstock; optionally wherein said applying the applied pressure for increasing the feedstock density of the feedstock includes increasing the feedstock density of the feedstock to be:
i) less than a first water density of the body of water above a critical submersion depth; and/or
ii) greater than a second water density of the body of water below the critical submersion depth;
optionally wherein said sequestering the pressurized feedstock comprises submerging the feedstock in the body of water;
further optionally wherein said sequestering the pressurized feedstock comprises disposing the feedstock in the body of water at a predetermined injection depth that is greater than the critical submersion depth; and/or
d) said applying the applied pressure comprises applying the applied pressure for enabling the feedstock to become negatively buoyant.

72. The method of claim 67, wherein said sequestering the pressurized feedstock comprises sinking the feedstock in the body of water after the at least one low-density structure of the feedstock is compressed.

73. The method of claim 67, further comprising:
determining a critical submersion depth below a water surface of a body of water for one or more fragments containing carbon and defining one or more gas pockets, the fragments having a first fragment density that is less than a first water density of the body of water above the critical submersion depth and that is greater than a second water density below the critical submersion depth;
disposing the fragments in the body of water at a predetermined injection depth that is greater than the critical submersion depth; and
permitting the fragments containing carbon and having the second density being greater than the second water density to sink to a floor of the body of water; wherein said disposing the fragments in the body of water includes exposing the fragments to pressure.

74. The method of claim 73, wherein said disposing the fragments in the body of water includes exposing the fragments to pressure for compressing the gas pockets to increase the first fragment density of the fragments to a second fragment density that is greater than the first fragment density;
optionally wherein said exposing the fragments to pressure comprises exposing the fragments to hydrostatic pressure from the body of water;
further optionally wherein said exposing the fragments to hydrostatic pressure comprises exposing the fragments to an increasing hydrostatic pressure that increases with a depth within the body of water, the increasing hydrostatic pressure further compressing the gas pockets and further increasing the second fragment density of the fragments to a third fragment density that is greater than the second fragment density.

75. The method of claim 73, wherein disposing the fragments in the body of water includes exposing the fragments to pressure for filling the gas pockets with water from the body of water to increase the first fragment density of the fragments to a second fragment density that is greater than the first fragment density.

76. The method of claim 73, further comprising:
a) characterizing feedstock for conversion into the fragments containing carbon; optionally wherein said characterizing the feedstock includes:
i) ensuring that the feedstock is suitable for submersion in the body of water; and/or
ii) determining a moisture content of the feedstock; and/or
iii) determining a size, shape or other dimension of the feedstock; and/or
b) determining whether an adjustment to a dimension of the fragments is needed; optionally wherein said determining whether the adjustment to the dimension of the fragments is needed includes:
i) sorting the fragments to determine whether a dimension of a selected fragment is greater than a first predetermined fragment dimension threshold, and reducing the dimension of the selected fragment based upon said sorting the fragments, and wherein said determining the critical submersion depth comprises determining the critical submersion depth for the selected fragment with the reduced dimension;
further optionally wherein said determining whether the adjustment to the dimension of the fragments is needed includes determining whether the reduced dimension of the selected fragment is greater than the first predetermined fragment dimension threshold, and further reducing the reduced dimension of the selected fragment based upon said determining whether the reduced dimension of the selected fragment is greater than the first predetermined fragment dimension threshold, and
wherein said determining the critical submersion depth comprises determining the critical submersion depth for the selected fragment with the further reduced dimension; or
ii) sorting the fragments to determine whether a dimension of a selected fragment is less than a second predetermined fragment dimension threshold, and increasing the dimension of the selected fragment based upon said sorting the fragments, and
wherein said determining the critical submersion depth comprises determining the critical submersion depth for the selected fragment with the increased dimension;
further optionally wherein said determining whether the adjustment to the dimension of the fragments is needed includes determining whether the increased dimension of the selected fragment is less than the second predetermined fragment dimension threshold, and further increasing the increased dimension of the selected fragment based upon said determining whether the increased dimension of the selected fragment is less than the second predetermined fragment dimension threshold, and
wherein said determining the critical submersion depth comprises determining the critical submersion depth for the selected fragment with the further increased dimension; and/or
wherein the first predetermined fragment dimension threshold is equal to the second predetermined fragment dimension threshold.

77. The method of claim 76, wherein said determining whether the adjustment to the dimension of the fragments is needed comprises determining whether an adjustment to a size of the fragments is needed; and/or determining whether an adjustment to a shape of the fragments is needed.

78. The method of claim 73, further comprising:
a) confirming that the fragments containing carbon remain submerged after sinking to the floor; and/or
b) determining that a predetermined amount of the fragments have been disposed in the body of water and terminating said disposing the fragments in the body of water based upon said determining that the predetermined amount of the fragments have been disposed in the body of water; and/or
c) documenting a mass of the fragments at the floor of the body of water.

79. The method of claim 67, comprising:
disposing one or more fragments containing carbon and defining one or more gas pockets into a hopper loading section of a hopper system;
pumping the fragments from the hopper loading section into a proximal end region of a discharge pipe system having a distal end region extending below a water surface of a body of water to a predetermined injection depth below the water surface being greater than a critical submersion depth below the water surface for the fragments; and
discharging the fragments containing carbon from the distal end region of the discharge pipe system,
wherein the fragments discharged from the distal end region of the discharge pipe sink to a floor of the body of water; and
applying pressure to the fragments moving from the proximal end region of the discharge pipe system to the distal end region of the discharge pipe system.

80. The method of claim 79, wherein said disposing the fragments includes delivering the fragments to the hopper loading section via:
a) a front-end loader system; or
b) a conveyor system;
optionally further comprising determining a mass of the fragments on a selected track segment of the conveyor system;
further optionally:
i) wherein said determining the mass of the fragments comprises determining the mass of the fragments via the conveyor system; and/or
ii) further comprising adjusting a speed of the conveyor system based upon the determined mass of the fragments.

81. The method of claim 79, further comprising delivering water to the hopper loading section of the hopper system, wherein said pumping the fragments comprises pumping the fragments and the water from the hopper loading section of the hopper system into a proximal end region of a discharge pipe system;
optionally wherein said delivering the water to the hopper loading section of the hopper system comprises delivering water from the body of water to the hopper loading section of the hopper system.

82. The method of claim 79, wherein applying pressure to the fragments moving from the proximal end region of the discharge pipe system to the distal end region of the discharge pipe system to increases a fragment density of the fragments, wherein the fragment density is greater than a water density of the body of water at the predetermined injection depth.

83. The method of claim 79, wherein:
a) the proximal end region of the discharge pipe system is disposed below the water surface of the body of water; and/or
b) the proximal end region of the discharge pipe system is disposed above the water surface of the body of water; and/or
c) at least a portion of the hopper system is disposed below the water surface of the body of water; and/or
d) at least a portion of the hopper system is disposed above the water surface of the body of water.

84. The method of claim 67, further comprising the use of a submersion vessel comprising an elongated body that includes first and second opposite end regions and that defines an internal channel extending from the first end region to the second end region; the first end region defining a first opening that communicates with the internal channel and that alternates between an open state for permitting access to the internal channel via the first opening and a closed state for inhibiting access to the internal channel via the first opening, the second end region defining a second opening that communicates with the internal channel and that alternates between an open state for permitting access to the internal channel via the second opening and a closed state for inhibiting access to the internal channel via the second opening, the elongated body including a pressure sensing port adjacent to the first end region and being configured for determining an internal pressure inside the internal channel and a water supply port adjacent to the second end region and being configured for controlling a fluid exchange between the internal channel and a fluid pressure source system, comprising:
positioning the submersion vessel in a loading position with the first end region being in the open state and the second end region being in the closed state;
disposing one or more fragments containing carbon and defining one or more gas pockets into the internal channel of the submersion vessel via the first opening of the first end region;
transitioning the first end region from the open state to the closed state;
submerging the second end region of the submersion vessel below a water surface of a body of water to a predetermined injection depth below the water surface being greater than a critical submersion depth below the water surface for the fragments;
disposing water into the internal channel of the submersion vessel via the water supply port; and
transitioning the second end region from the closed state to the open state,
wherein the fragments exit the internal channel via the second end region and sink to a floor of the body of water.

85. A system for creating submerged carbon-containing material and comprising means for carrying out the method of claim 67.

86. A computer program product for creating submerged carbon-containing material and comprising instruction for carrying out the method of claim 67, optionally wherein the computer program product is encoded on one or more non-transitory machine-readable storage media.
